(19) United States
(12) Patent Application Publication
(10) Pub. No.: US 2016/0048889 A1
(43) Pub. Date: Feb. 18, 2016

(54) COMPUTER-IMPLEMENTED SYSTEM FOR SHARING VIRTUAL PRODUCT SAMPLES

(71) Applicants: RWACHSBERG HOLDINGS INC., Toronto (CA); GABRIELE GALIANO GROUP LTD., Vaughan (CA)

(72) Inventors: Richard Wachsberg, Toronto (CA); Paul Gabriele, Vaughan (CA); Giovanni Galiano, Vaughan (CA)

(21) Appl. No.: 14/771,406

(22) PCT Filed: Dec. 13, 2013
(86) PCT No.: PCT/CA2013/050965

§ 371 Date: Aug. 28, 2015

Related U.S. Application Data
(60) Provisional application No. 61/736,573, filed on Dec. 13, 2012.

(51) Int. Cl. G06Q 30/02; G06F 17/30; G06Q 50/00

(52) U.S. Cl. CPC G06Q 30/0276; G06Q 30/0214; G06Q 50/01; G06F 17/30368; G06F 17/30867; G06F 17/3053; G06F 17/30525

(57) ABSTRACT

The invention relates to a computer-implemented method and system for sharing “sample bags” consisting of virtual samples of products and services over a computer network and performing searches for samples or sample bags. A template is provided for compiling a virtual sample bag by a first user, which may be private for viewing and sharing only by designated other users or public. The sample bag is stored in the host database in a user-searchable format. A second user may request to share the sample bag from a second user and the sample bag is then communicated to the second user for viewing and sharing. The second user may copy (“sample”) the samples from the shared bag into another bag. The invention also relates to a computer-implemented method and system for searching for samples in which search is performed within a sample bag database of the host computer and also over the web. The search results may be grouped according to predetermined criteria such as price or sample location.

### FIELD OF THE INVENTION

The invention relates to a method and system performed over the worldwide computer network for searching and sharing information relating to virtual samples of products and services consisting of images, information and other data in digital form relating to selected products or services. The invention further relates to methods and systems to allow creators and designers of new products and interested consumers to disseminate information relating to products or services and receive feedback and potential sales from a targeted consumer market and related search systems and methods. The invention further relates to searching for samples and collections of samples over a computer network

### BACKGROUND

The protocol which operates over the worldwide computer network known as the worldwide web (the “web”) has opened up many new ways to disseminate goods and services and interact with a network of individuals and businesses that share common interests despite being widely separated by geography and other barriers. For example, services such as eBay and Amazon.com allow suppliers of goods or services to reach a worldwide market with a relatively low investment of resources on the part of the sellers. At the same time, such services allow interested businesses and individuals to reach a highly targeted audience such as persons who are searching for a product or service with relatively narrow market appeal. As a result, the worldwide computer network provides a highly efficient mechanism for marketing and purchasing goods and services. In addition, social networks such as Facebook and Twitter have greatly expanded the ability of individuals, businesses and other entities to establish networks and to interact between networks, thereby allowing for a highly efficient transfer of information within self-selected communities and networks.

One such community consists of individuals, businesses and other entities involved in creating new products and services and those with a particular interest in new products or services that may be still in the development stage. For example, such a community exists for consumer products such as interior design, fashion, sporting goods and others in which aficionados of such products have a keen interest in becoming involved with the development phase of such products. For developers of such products, early-stage interest and feedback can be invaluable. As well, aficionados often wish to share information about such products amongst like-minded individuals, as well as provide input into the creative process and obtain samples of new products. Businesses and other developers of new products or services also have a strong interest in establishing networks for developing their new products and ultimately marketing such products.

Such networks can represent a form of “open innovation” that can greatly assist a product or fashion designer operating on a small scale, who might otherwise have difficulty in establishing a network of persons interested in sampling the new product or service and providing input into the creative development process. However, the risk can exist of becoming swamped with comments and contributions, in particular by those who may not be highly actively involved in this community. There is thus a need for a semi-private system that permits wide dissemination of certain information while also providing the capability to narrowly focus the sharing of commentary and other exchanges.

The relevant community has an interest in sharing information about new products and services, particularly those that are in the design stage. Members of this community share a common interest in participating in the development of cutting edge new products and services. There is a mutual interest on the part of purchasers, who can thus be provided with “cutting edge” and exclusive new products, and designers and innovators who are provided with feedback, assistance and potential marketing contacts for their new product or service. At present, websites such as Pinterest provide a network that is intended to target this community. As well, internet-based methods and systems for providing information relating to goods or services have been disclosed in the following references:

U.S. Pat. No. 8,160,939

### U.S. Application 2009/0234744

### JP 2010262614A

### JP 2010198061A

There exists a need for an improved internet-based method and system for facilitating interactions within the community of interested consumers and innovators of new products and services. In particular, there is a need for improved methods to permit sharing of samples of new goods or services and feedback within a select network that provides a means to both share information. In particular, there is also a need for an internet-based network that provides easy and seamless interaction between and within groups of consumers, innovators and other members of this community.

In addition to sharing information, the function of searching for information is central to the use of the web. Conventional search engines such as Google typically conduct searches of and within websites. Searches are typically based on key words or other inputs. Conventional search engines suffer shortcomings when searching for specific products or services that are incorporated within a “shared sample” network, and in particular in integrating such searches with features incorporated in the shared sample network.

### SUMMARY OF THE INVENTION

According to one aspect, the invention relates to the creation, management and sharing of “sample bags” between selected members of a network. A sample bag is an assemblage of virtual samples that consist of digital images (still or moving), text and/or sound files that correspond to a specific product or service capable of being depicted digitally. A sample bag exists as data that is transmitted, stored and processed in the form of computer-readable signals and which can be transmitted over the Internet. The system is operative with a network composed of a host computer (referred to herein as the “host”) operatively connected (for example over the Internet) to multiple nodes consisting of computer terminals operated by users such as members (who in turn are composed of several categories) and members of the public. The term “user” as used herein refers to any person (an individual or other entity) who may operate a node, whether such user is a registered member of the network or a non-registered member of the public.

A virtual sample may depict a product that is in development or newly developed, although this is not required. A sample bag template is generated by the host. The template is then manipulated by a user (normally a member) in which the sample bag is “filled” with virtual samples and various keyword-type “tags” are created to identify and categorize the samples individually and collectively.

In one aspect, the invention relates to the sharing of sample bags amongst selected members, wherein the selected members jointly share and contribute to a shared sample bag. According to another aspect, the sample bag may be available to the membership at large or selected categories of membership at large or the general public. When thus available in an essentially non-selective (or selective only by class of membership) fashion, the “sharing” function may be disabled and the making available may be limited to public commentary. As well, commercial users may permit members and other users to purchase selected articles within a member's sample bag.

According to one aspect, the invention relates to a method of sharing virtual samples of products or services over a computer network comprising the steps of:

a) establishing a data exchange network operative over a computer network between a host comprising data processing and storage components and a plurality of user-operable nodes. Each node comprises a computing device normally having data processing, entry and storage components and a user interface. A node can be associated with a user who is either a member (who may in turn be a private member or a commercial/public member) or a public user. A “member” is typically a registered user who is authorized to generate and/or manipulate sample bags by adding or removing samples, and a “public user” is a non-registered person who has limited authorization such as the right to view and comment on samples but is typically not authorized to generate or manipulate sample bags.
b) in response to information entered into a mode by a first member, generating a sample bag in the host database comprising virtual samples of products and/or services and applying a selected designation of the sample bag, such as private, commercial, public and others. A private sample bag may be both viewed and shared between invited members and a public sample bag may be viewed by any person but is not accessible for sharing;
c) in response to a request from the first member to invite a second member to share the sample bag, transmitting to the second member an invitation. In response to an acceptance of the invitation, updating the host database to designate the sample bag as a shared sample bag wherein the first member and an invited second member can each display the shared sample bag on a user interface at a node, copy virtual samples from the shared sample bag into other sample bags (a “sample it” function), post comments linked to said virtual samples and add new virtual samples to the shared sample bag; and
d) optionally permitting a user to link to a website of public member for the distribution or sale of a sample from the sample bag.

The method can optionally permit a member to generate a tag for association with a sample bag. The tag can include descriptive terms or phrases to relevant to the samples in the sample bag. The member may also modify an existing tag. The tags are stored in the data storage component of the host. The method also permits a user to search within stored tags and within sample bags for selected tags and sample to generate a list or display of relevant sample bags.

Optionally, a public (commercial) member may generate a link to its own website to permit a user to order physical embodiments of the virtual samples. Optionally, generation of this link and/or actuation of the link by a user triggers a payment to be made from the public member to the host or host operator.

The sample bag can optionally be identified by at least one tag and by a graphic representation of at least one of said virtual samples within said sample bag.

The method can further include the steps of generating a stored list of contacts within the host database identified by email addresses or usernames for establishing a network for private sharing of the sample bags. The list of contacts are entered by a member and stored in the host database. The step of establishing a shared sample bag can comprise the step of establishing a database corresponding to said shared sample bag for storing data corresponding to said shared samples wherein each of said shared samples is identified with the donor source of the sample and the recipient member with whom the sample has been shared.

According to another aspect, the invention relates to a system for exchanging and sharing virtual samples of products or services between members over a computer network. The system comprises a host computer for communicating with user nodes over a computer network and for compiling within a host database in response to a user request, a virtual sample bag containing virtual samples of products or services. A sample bag may be designated as private or public. A sample bag, consisting of one or more virtual samples and optionally one or more descriptive tags, is generated by and is under the control of a member for viewing, sharing and other operations performed by others. The system also includes:
an interface consisting of a virtual dashboard interactive between the host and a first node to permit a first user to generate a sample bag or add a virtual sample to a pre-existing sample bag, remove virtual samples from a sample bag, and generate, modify or delete a descriptive tag associated with the sample bag. The dashboard also permits the user to elect between public and private access to the sample bag, wherein public access permits any person to post comments relating to a sample in the sample bag and private access establishes a shared sample bag that with an invited member. An invited member can either post comments relating to the sample bag and/or transfer a copy of a sample to his own sample bag and/or add a new sample to the shared sample bag. A transferred sample may optionally be identified as having been shared with the other member; and
means for a commercial (public) member to optionally permit a user to link to a public website that permits the public member to directly distribute or sell a sample from the sample bag.

According to another aspect the invention relates to a computer-implemented method for performing a search over a computer network comprising a host computer and user nodes, said host comprising a database of virtual sample bags comprising an assemblage of virtual products or services wherein said sample bags are compiled and transmitted over the network by users. The search comprises the steps of receiving at said host computer a search inquiry from a first user, performing a first search within the sample bag database of said host, performing a second search within the web and transmitting the results of said first and second searches to said first user.

The second search may comprise the step of grouping the search results according to predetermined categories, such as a selected price of said samples, geographic location and industry sector.

The second search may comprise a meta search conducted within databases of selected publicly accessible search engines.

The first search may comprise an initial computer-implemented parsing step wherein search terms entered by the first user are compared with data associated with said stored sample bags to generate a parsed search output. The first search may also comprise the further step of ranking the search results according to a combination of relevance to sample bags within said sample bag database and number times said sample bags have been previously selected by others of said users for sampling.

The first search may comprise the further step of compiling a database in said host of commercial users wherein a payment is transferred by said host when a sample bag of one of said commercial users is identified in said search.

Sample bags and/or samples within sample bags identified in said first search can be resampled by said first user using a “sample it” function over the network to the account of the first user. The host computer then updates its database to tabulate said resampling of the selected sample bag and/or sample. The host can also add an additional sample or generate a new sample bag of the first user to insert a sample located in said second search, in response to a request by the first user and uploading of computer data by the first user transmitted over the network.

According to a further aspect, the invention relates to a system for exchanging and sharing virtual samples of products or services between members over a computer network comprising a host computer and multiple node computers associated with users. The system comprises:
a computer-generated template accessible over the network to said users for compiling in a database of said host a virtual sample bag or updating existing previously compiled virtual sample bag comprising an assemblage of virtual products or services, said template comprising a user interface transmitted over the network to a first of said users;
a database and computer program on computer-readable media to process and store data at said host transmitted to the host from the first of said users to the host over the network relating to a virtual sample bag and a designation of the status said sample bag as being private for viewing and sharing only by designated others of said users or public for sharing by designated others of said users and viewing by any person over said network;
a computer program on computer-readable media for receiving a request at said host to share said sample bag from a second of said users and responsive to said request, causing said host computer to identify from data stored in said host whether said second user is a designated user and transmitting said sample bag for viewing and sharing by a designated one of the second users to the node of said second user, and then updating the host database to designate said sample bag as being shared between said first and second users
a computer program on computer-readable media for receiving at said host from a designated one of said second users a request to perform one or more of copying at least one of said virtual products or services into a sample bag of said second user, posting a comment in said shared sample bag or adding a new virtual product or service into the shared sample bag; and for updating the host computer database to modify the sample bag as requested by the second user and store said modified sample bag.

### DEFINITIONS

“user interface” or “UI”: a user interface that allows a user of a computing device to interact with the device using images, text, or other means.

“Graphical user interface” of “GUI” is a user interface that displays images on the screen of the user's computing device (and optionally also text) that allows a user of a computing device to interact with the device using images and manipulation of the images displayed on the screen.

“Tag” means a keyword or term that is associated with selected information in a database. A tag allows the host computer to classify and identify information that may be uniquely associated with a user or group of users. A tag may be displayed on a user interface, such that clicking on the tag retrieves the selected information from the host for display on the user's screen.

“Sample” means a virtual product or service that is displayed on the screen of a computer device graphically and/or with text. A sample may depict an article or service that is still in the design phase or one which has a physical existence. Unless otherwise specified, a “sample” refers to a virtual sample rather than a physical embodiment of an object or an actual performance of a service.

“Sample bag” means a depiction, displayed on the screen of a user node, of a specific collection of goods and/or services. A sample bag may be displayed either graphically or with text, or a combination of the two. Essentially, a sample bag is a virtual assemblage of selected products and/or services organized around a theme that may be selected by the user or another person.

### BRIEF DESCRIPTION OF THE DRAWINGS

FIG. 1 is a schematic illustration of a computer network according to the present invention.

FIG. 1A is depicts a sample bag, showing virtual samples contained therein.

FIGS. 2A though 2F serially depict a flow chart showing operation of the present invention.

FIGS. 3A through 3C serially depict a flow chart showing operation of the public section and marketplace portion of the invention.

FIGS. 4A-4M depict graphic user interfaces generated during operation of the present invention.

FIGS. 5A through 5D serially depict a flow chart that shows operation of a search system and method according to the invention.

FIG. 6 is a flow chart that shows further particulars of the search system and method.

FIG. 7 is a flow chart that shows further particulars of search system and method.

FIG. 8 is a flow chart that shows further particulars of the ranking method performed during the search functions.

### DETAILED DESCRIPTION

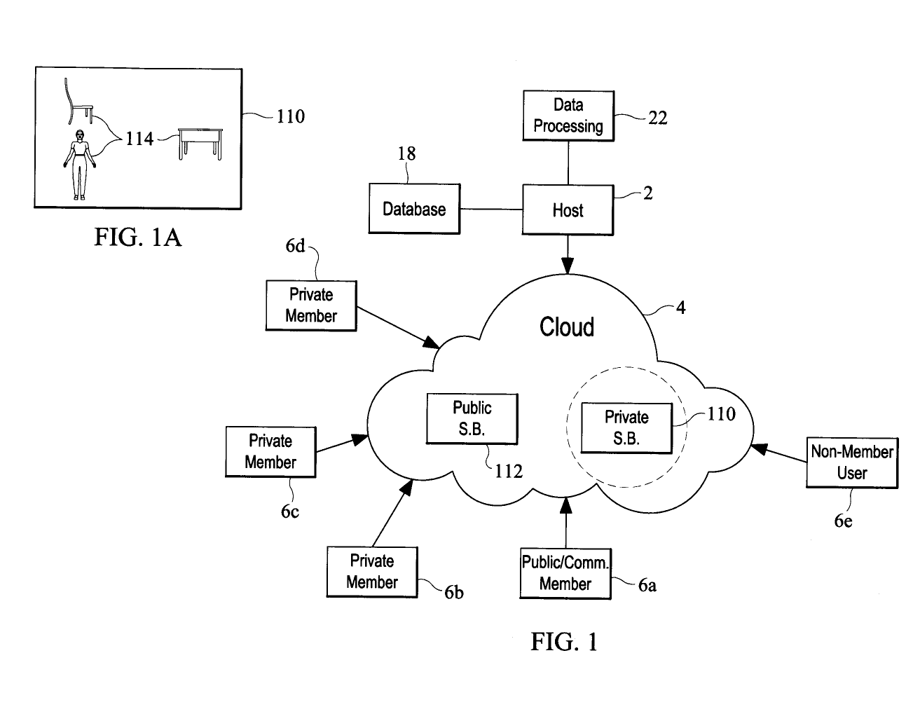

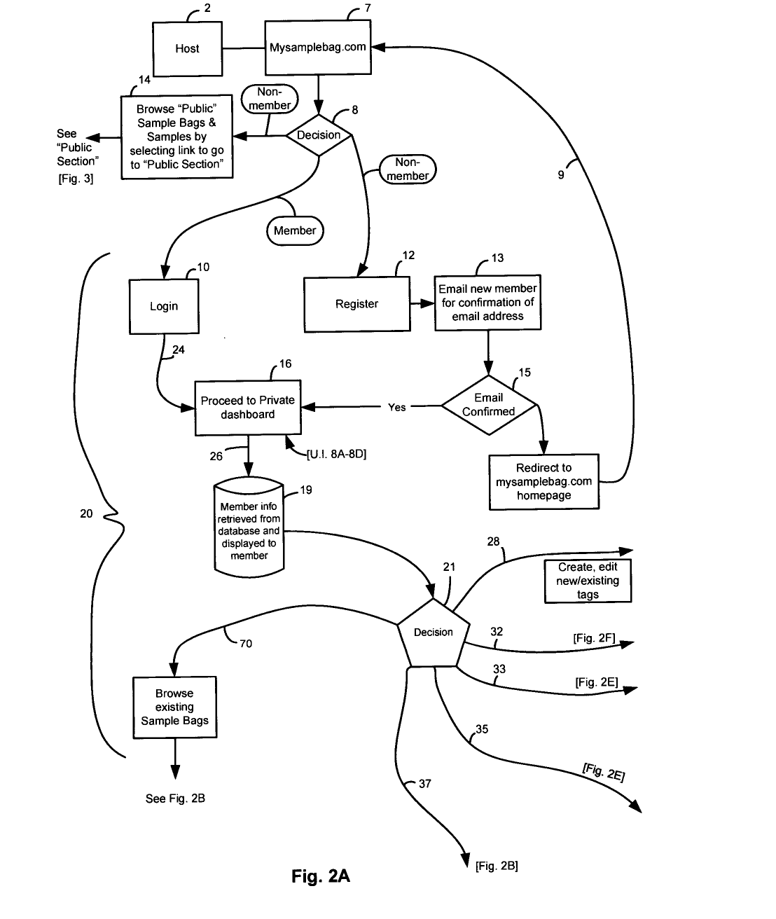

Referring initially to FIG. 1, the embodiment described herein is operative in the environment of the worldwide computer network known as the worldwide web, which comprises uniform protocols that allow computers to communicate and interact over the Internet. The present system and method relates to a computer network 1 that comprises one or more hosts 2. Host 2 normally comprises one or more computer servers that provide essentially permanent, fulltime connectivity to a network 4 that is operative over the Internet. Host 2 comprises a data storage/database 18, computer program instructions and a data processing system 22. Host 2 provides computer program instructions to user node computers 6 and provides data storage in a protocol commonly referred to as “cloud computing”. As such, network 4 can be referred to as a “network cloud”. Host 2 can be located in a jurisdiction whose laws and regulations permit operation of the system described herein.

A plurality of user nodes 6 may at any time connect via an internet connection to cloud 4 so as to permit connectivity with host 2. User nodes 6 may comprise any communications device that is capable of exchanging digital signals with host 2 via cloud 4, such as a mobile telecommunications “smart phone”, a PDA or a computer or computer-driven device linked by modem and Internet Service Provider (“ISP”) to the Internet. An essentially unlimited number of user nodes 6 may connect to host 2, limited primarily by the physical capabilities of host 2 and the data transmission “bandwidth” between host 2 and node 6. For simplicity, five representative user nodes 6 are described herein, namely user nodes 6a 6b 6c, 6d and 6e respectively. User node 6a is associated with a “business member”. User nodes 6b, 6c and 6d are associated with private members and node 6e is associated with a public user. The differences in member status will be described in detail below.

Optionally, user nodes 6 may be specifically configured for interactivity with host 2 by downloading of software that is specifically designed for operation of the present system and method. This software is in the form of html or web based coding that generates templating displayed to the member/user. While navigating the various pages of the site, the program essentially “downloads” the different page templates.

A template displayed to a user consists of text, graphics or other information which is gathered from a database or file system and placed in the template for display to the user.

Members associated with nodes 6a, 6b, 6c and 6d are required to log in to the system, preferably with a public user name and private password. The user of node 6e may optionally be required to register with the host, to log in with a user name and password, or optionally member 6e may freely access the system without a specific log-in step.

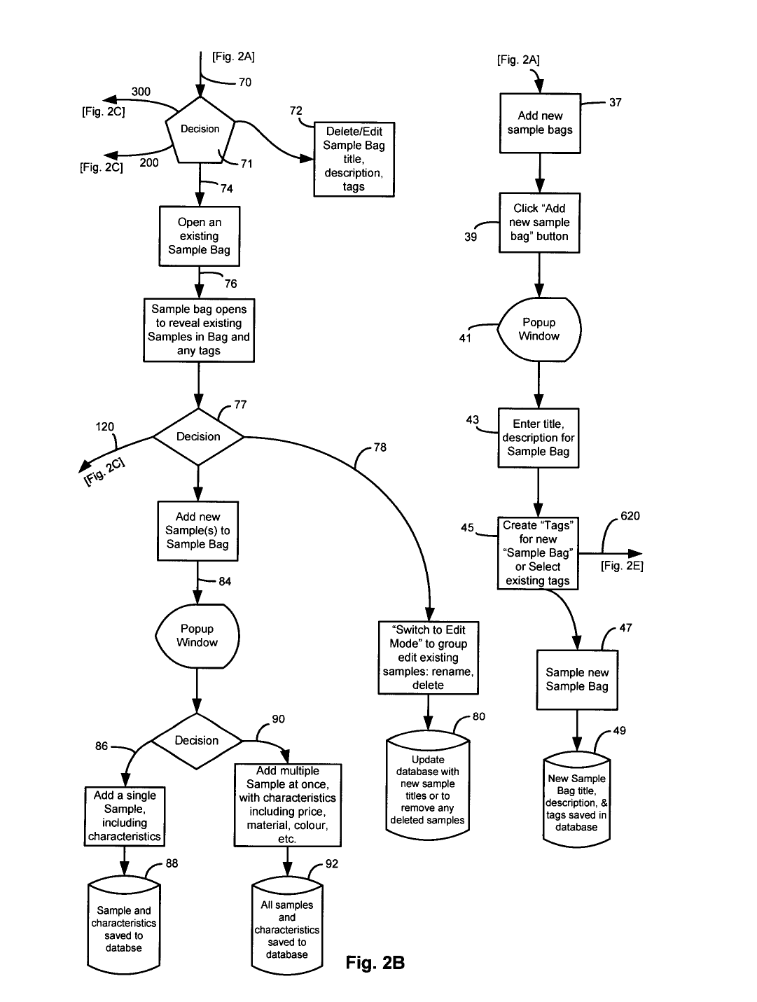

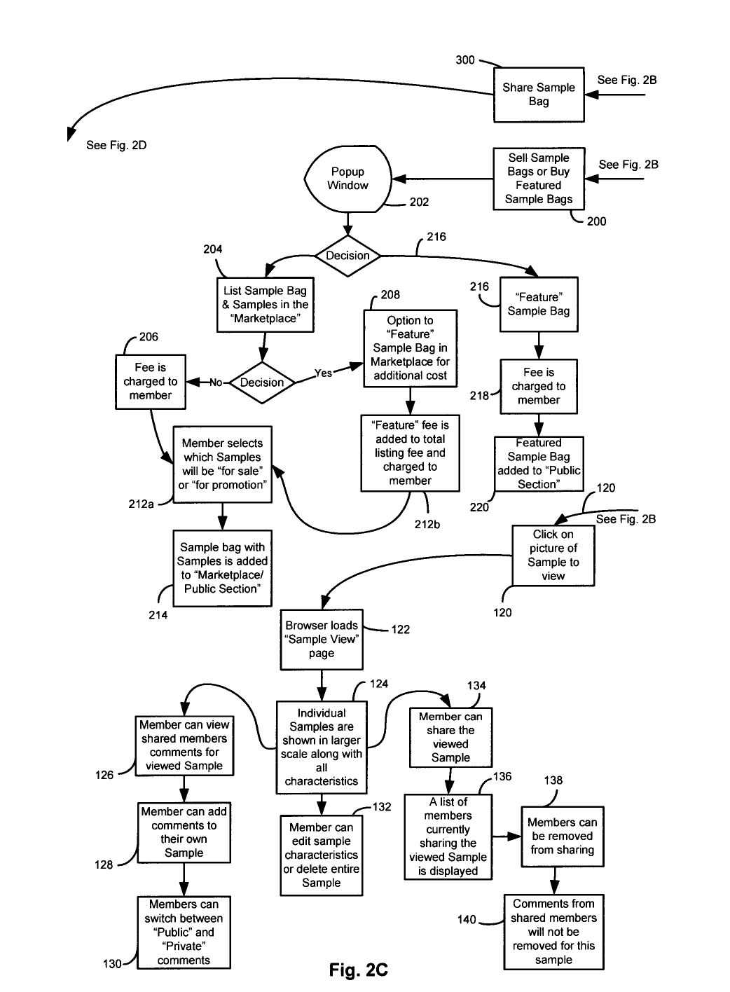

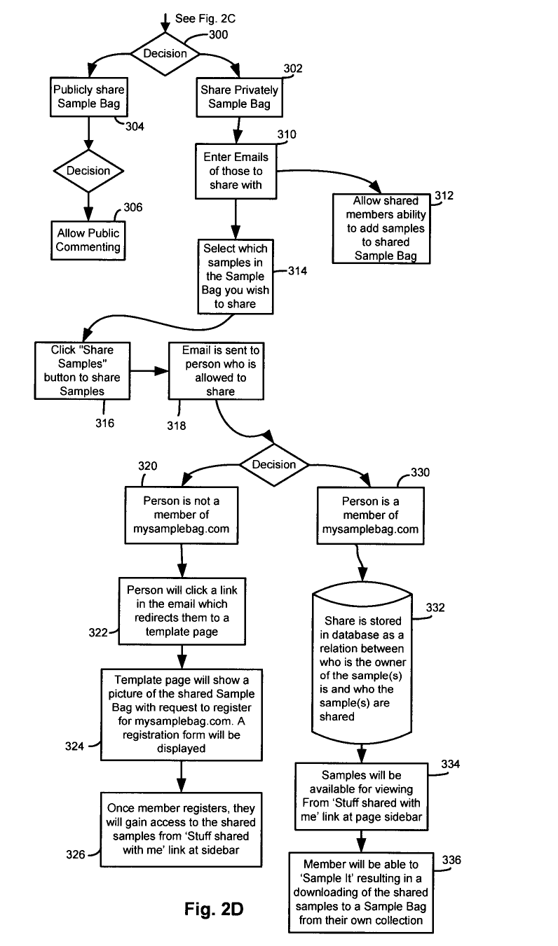

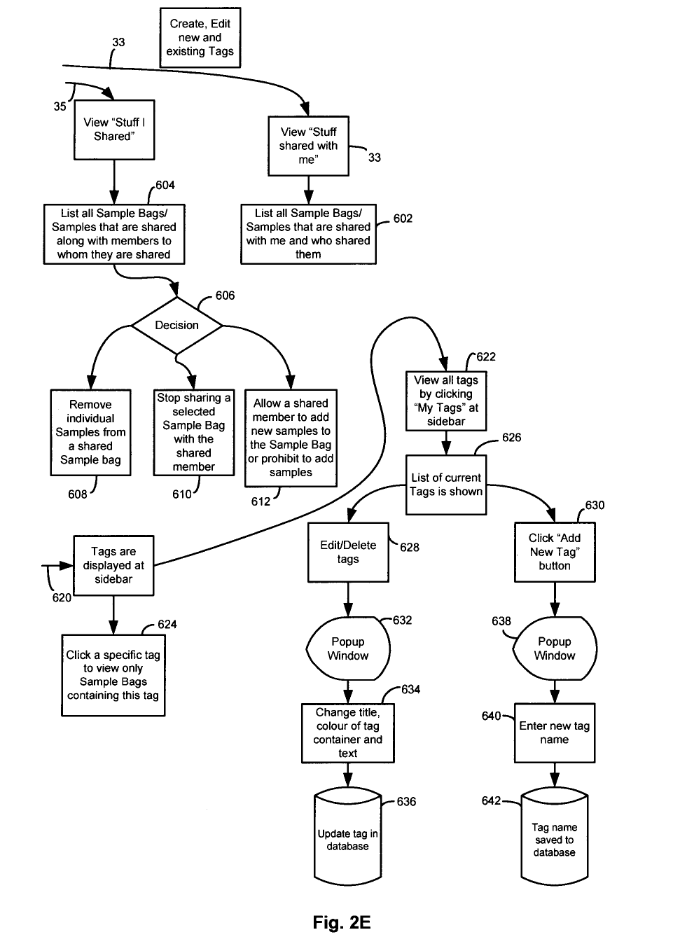

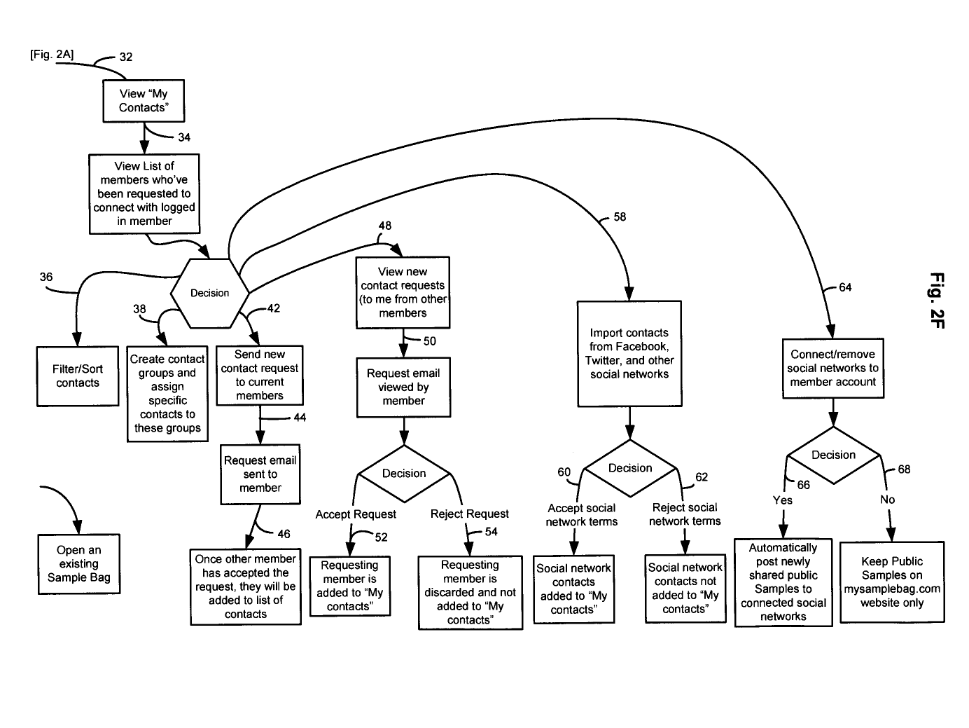

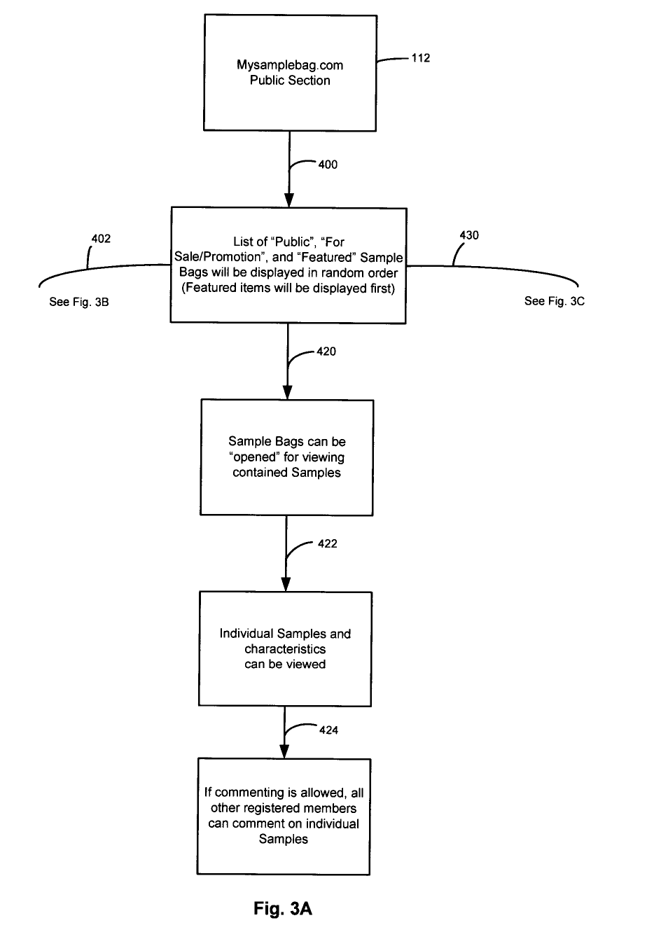

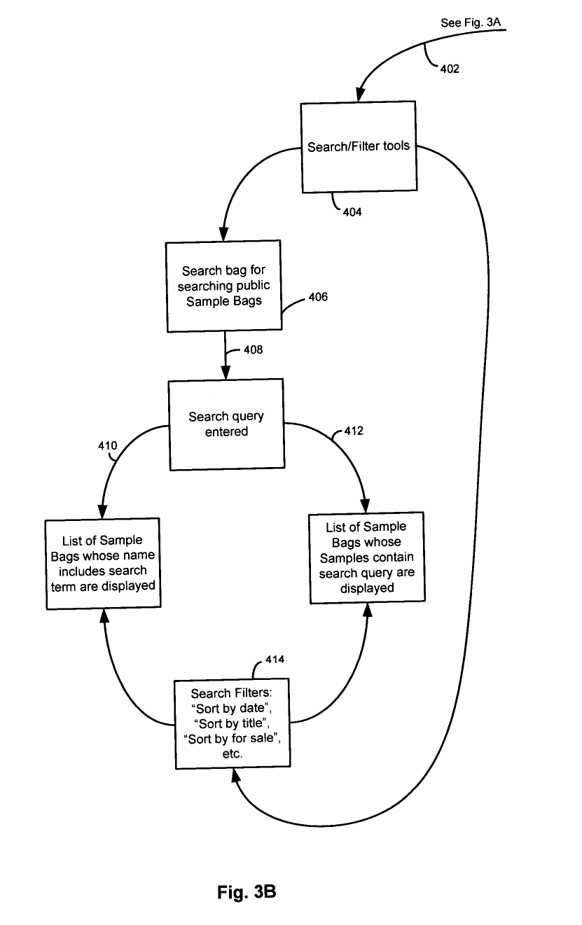

Referring to FIGS. 2A-F, host 2 hosts a website 7 that has a public portion that may be accessed by any user of the Internet. The host website 7 serves as a portal that can be accessed by all members of the public, including registered members and non-members who may simply wish to browse the system. Website 7 presents a user who connects thereto with options 8. A first option is for a current member to log-in at 10. A new member can register for the site at page 12 and non-member who do not wish to register may use a public area of the website at 14. The non-member may then proceed to the public area of the website, shown in FIG. 3 and discussed below.

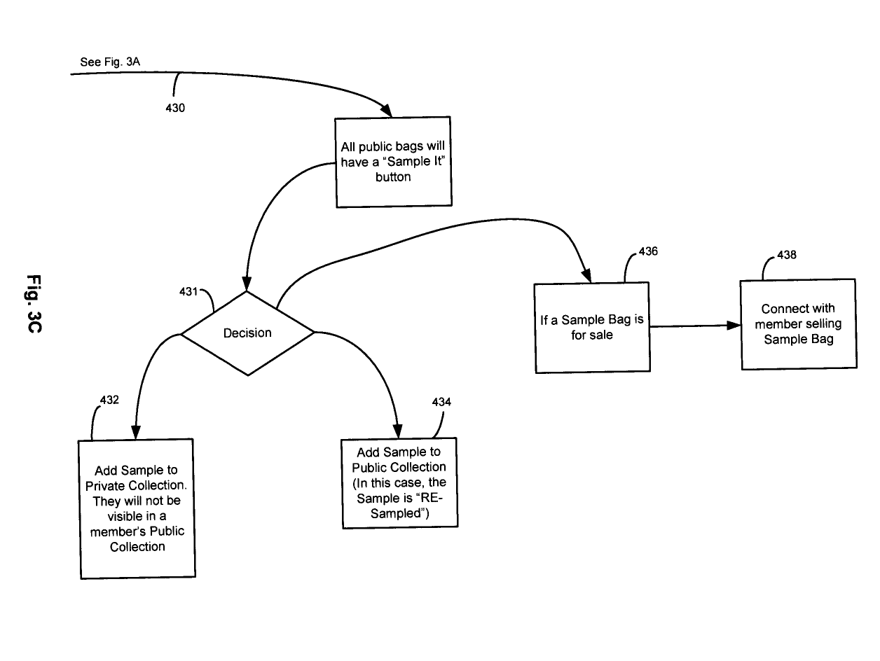

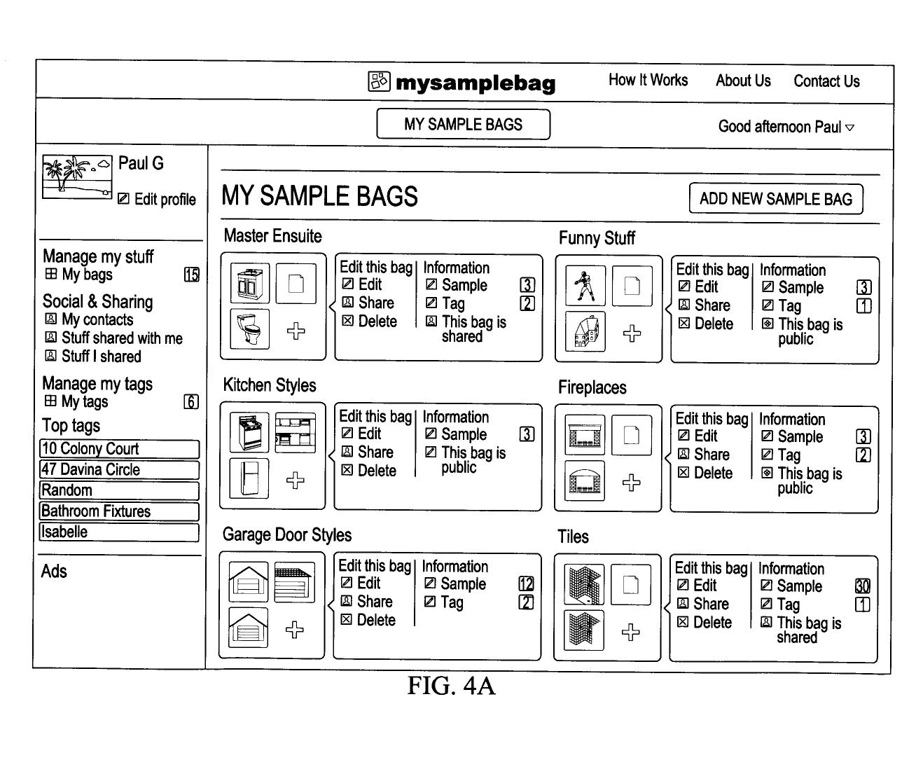

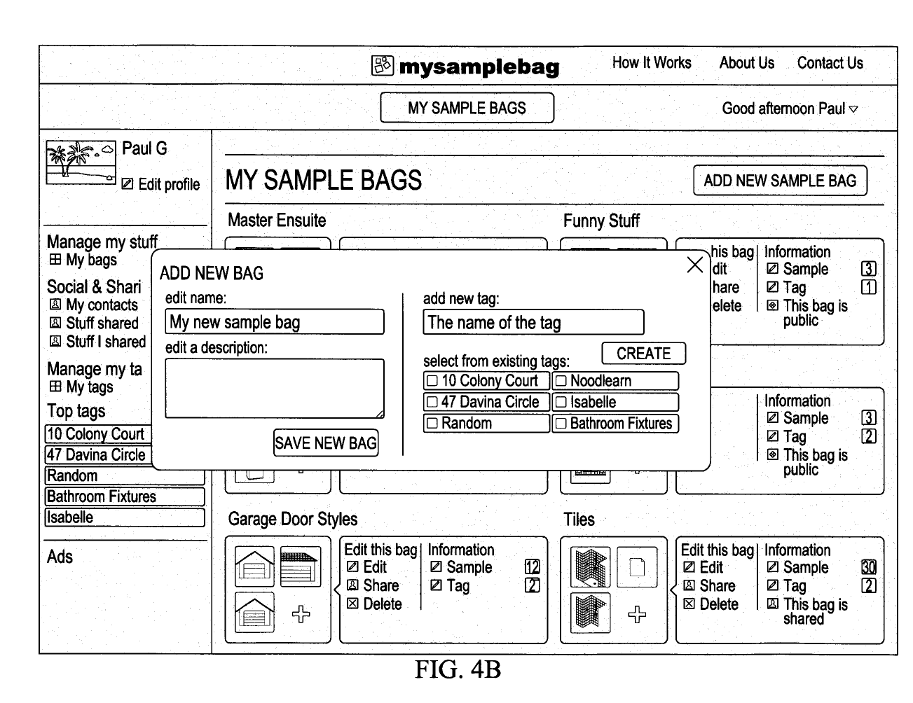

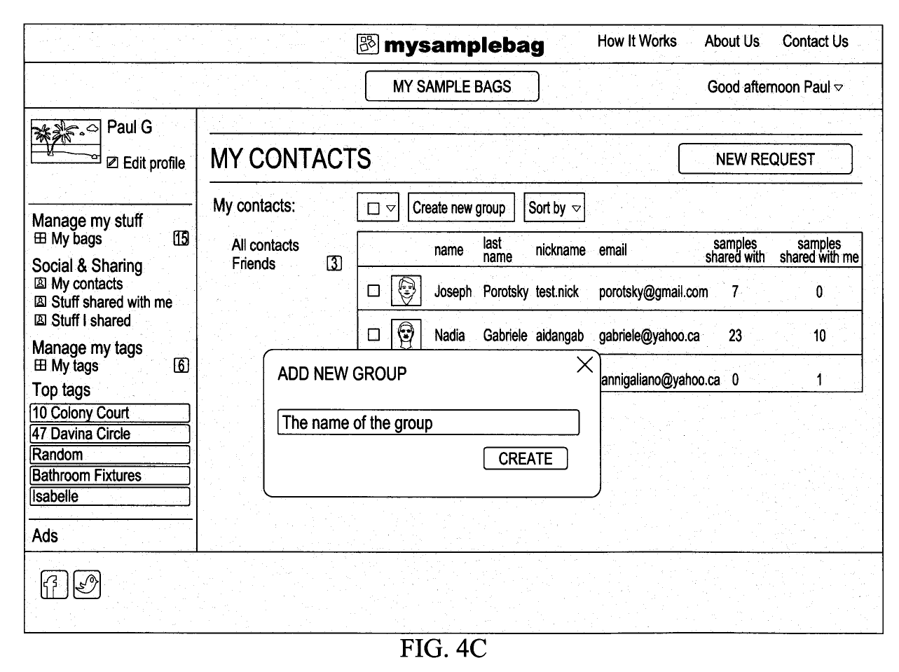

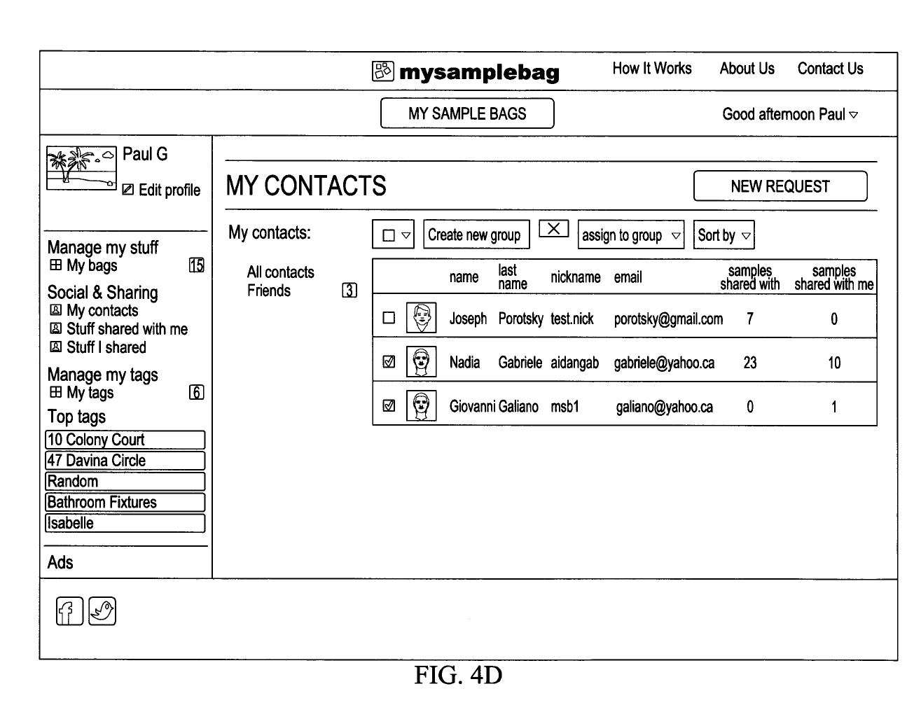

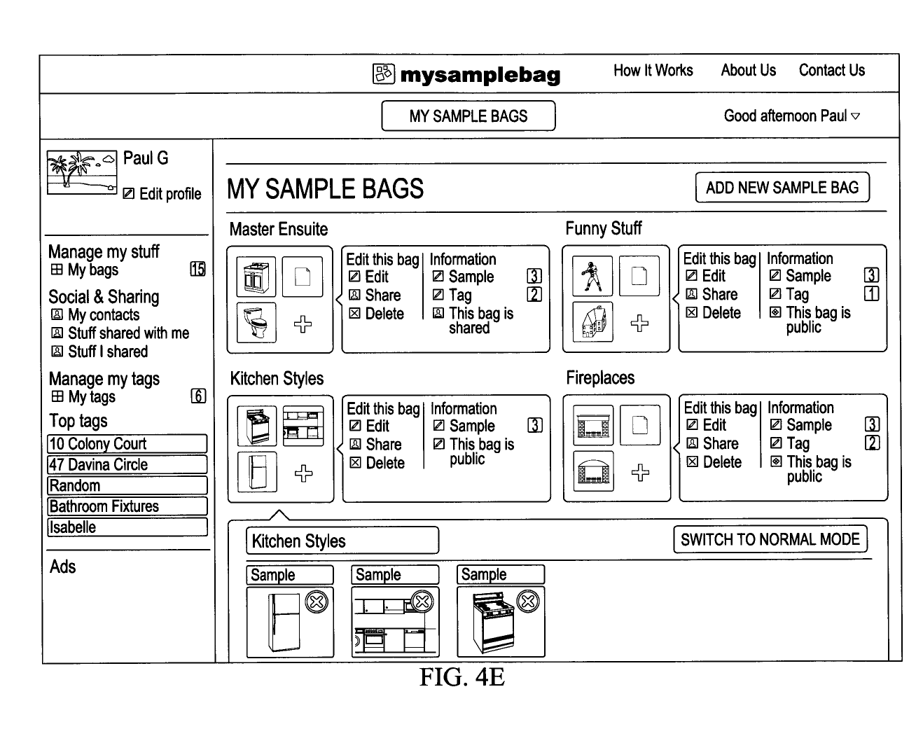

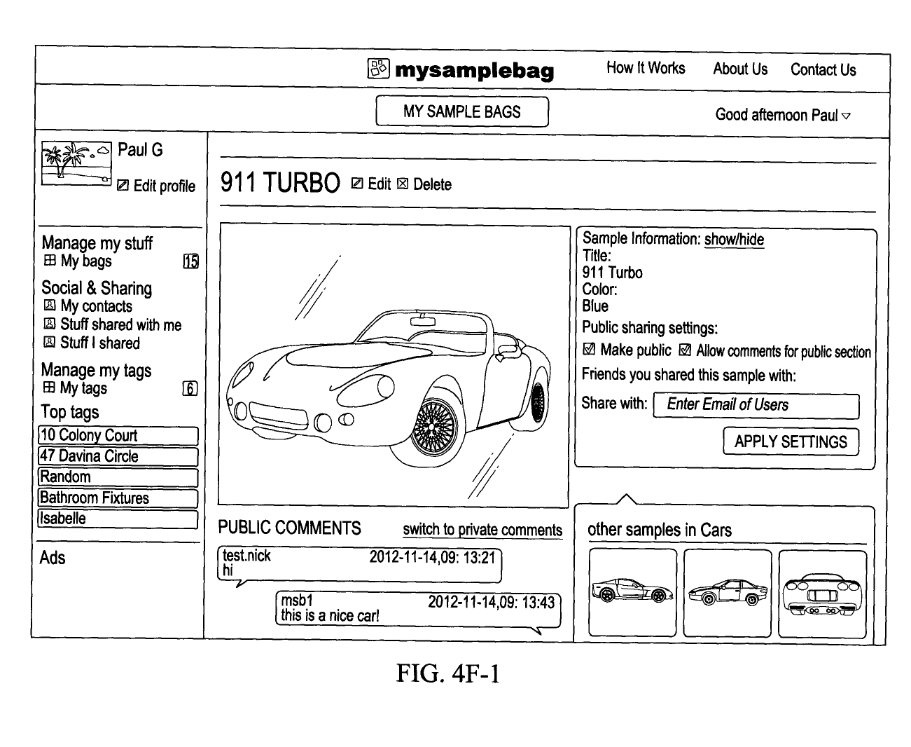

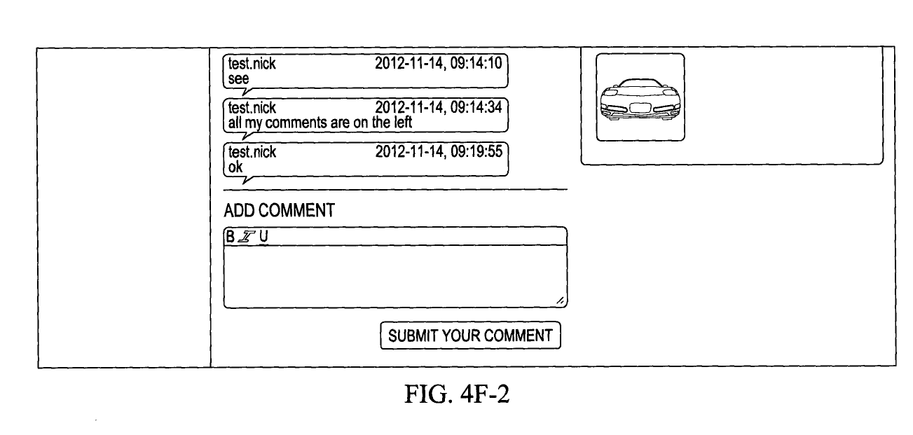

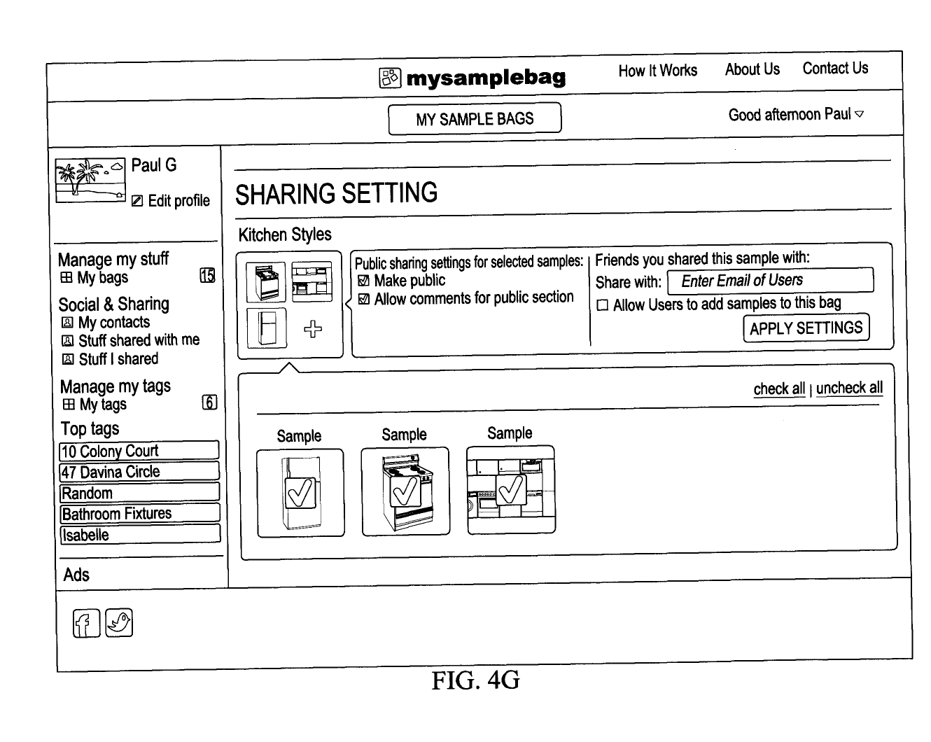

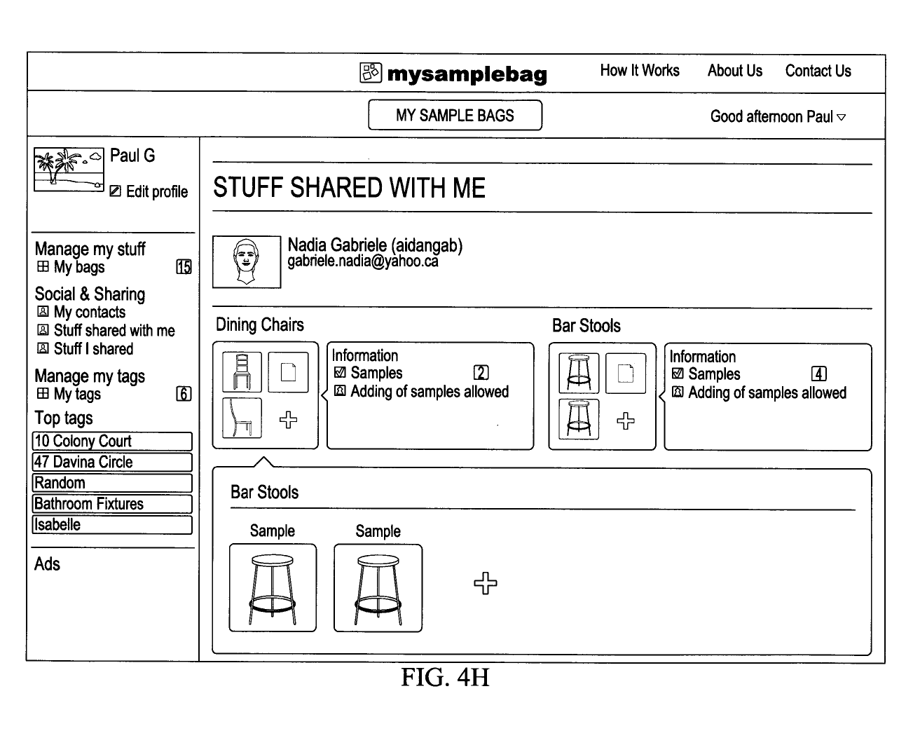

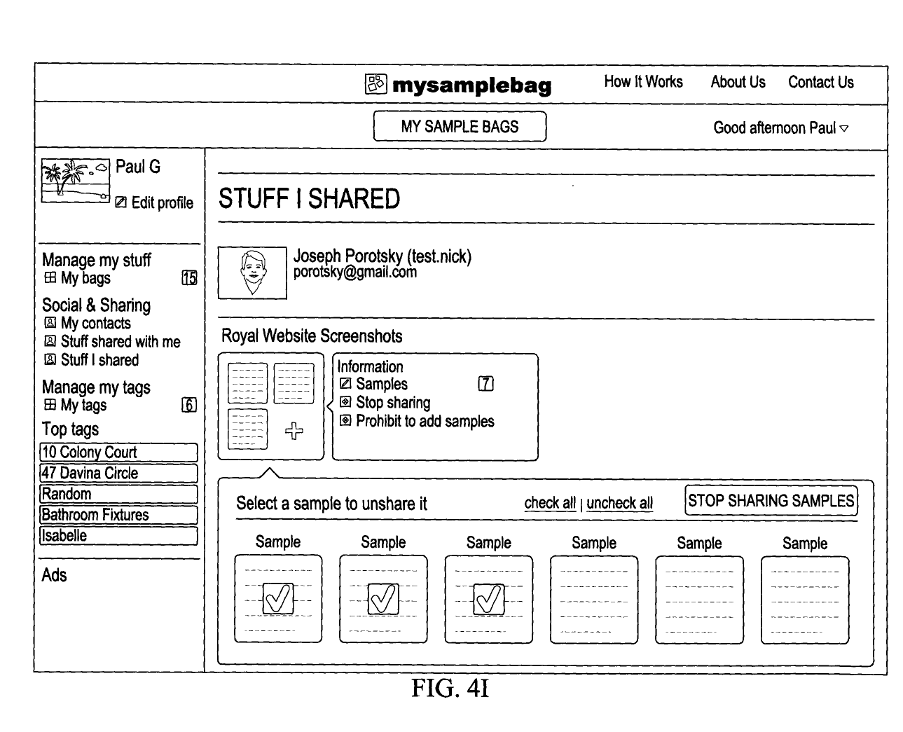

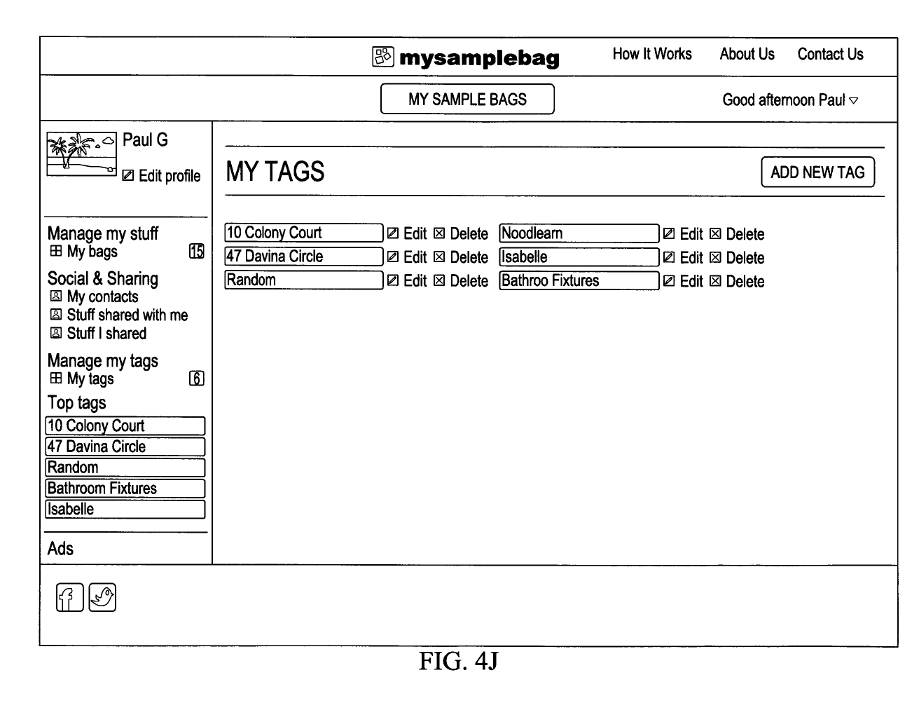

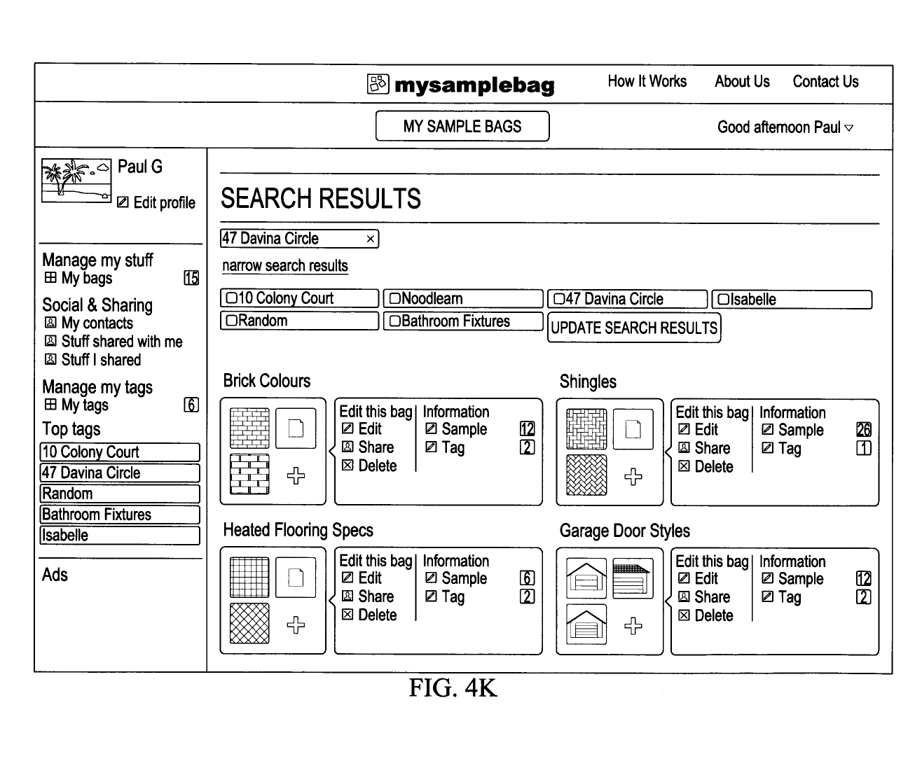

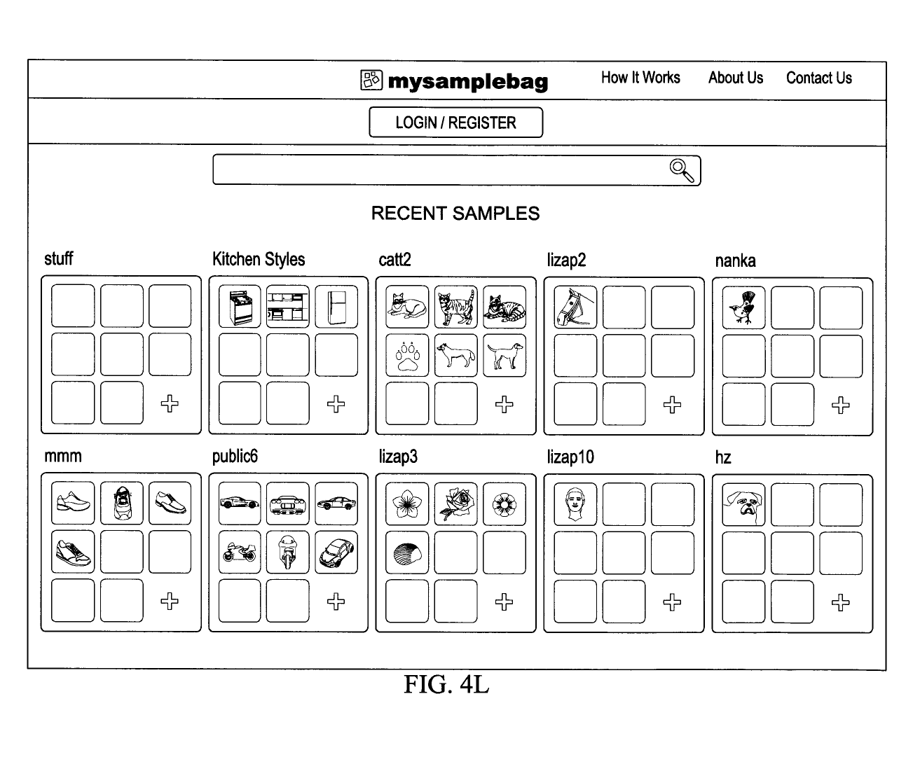

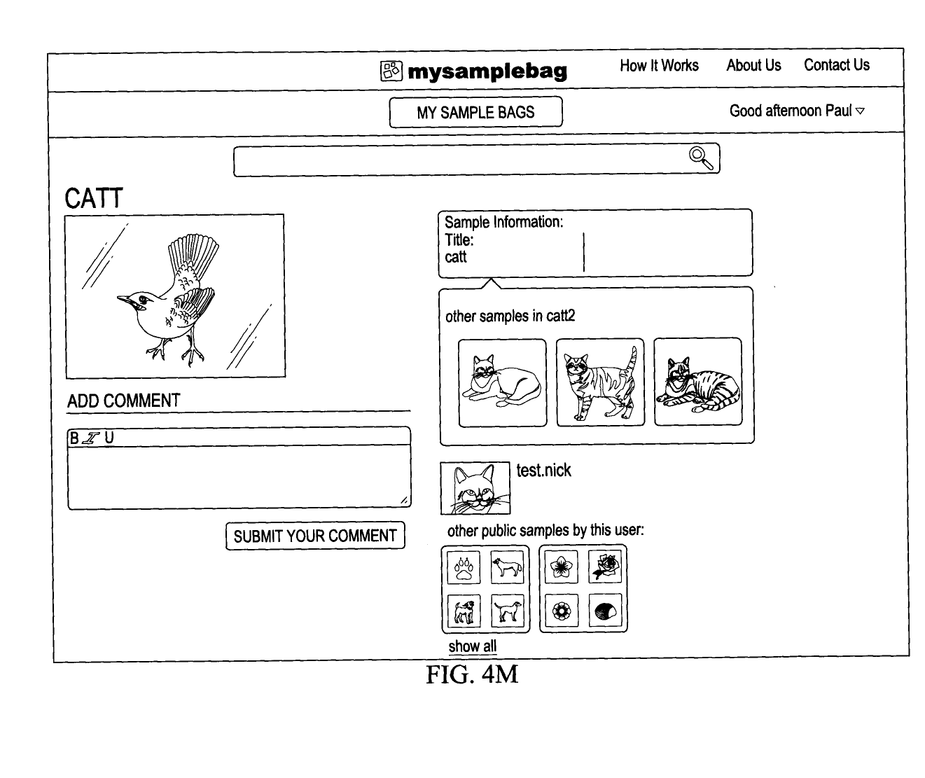

A private section 20 of network 1 comprises a computer network established between host 2 and any number of nodes 6a-d. A registered member can access section 20 via a secured connection to host server 2 at login step 10. Upon log-in 10 by an existing member, a member 6a-d is directed at step 24 to a selected private member dashboard 16, which provides private website page for that member. Dashboard 16 comprises a selected one of interactive user interfaces (“UI”) 8a-8d, which are displayed to the user depending on the membership type or category of the user. In one aspect, the user interface comprises a graphic user interface in whole or in part. UI's that comprise these dashboards are depicted in FIGS. 4A-4M. UI's 8a-8d provide the capability for the user to upload and manage virtual samples 114 including sharing of virtual samples 114 and private sample bags 110 with other selected members, or a more limited sharing of public sample bags 112, as will be described below. The UI 8d displayed on the screen of node 6a of a business member, in addition to the above, also provides the user with the ability to supply physical samples to other members using an online ordering system (e-commerce-based), either by way of commercial sale or for free, as described below.

At login step 10, the member's identity is verified as follows:

The member's email address, username and/or password is compared against those stored in the database. All characters must match in the same order for the identity to be verified. The password is encrypted upon submission in the login form. Encryption can be done using a specific code with the encrypted password being compared to the encrypted password stored in the host database, to ensure that a match is identified.

Upon verifying the identity of the member, the server provides access to the member's personal dashboard 16. This process can take place for any number of members simultaneously, subject to limits associated with the host server. The node 6d associated with a public user does not form part of this network unless and until this user joins the network as a private member and logs on or is connected as such. On connecting with the host 2, the screen of user nodes 6a-c can be configured to display the options of using the website via a public section 30, logging in as an existing member, or registering as a new member. Host 2 then generates personal dashboard 16 that is unique to the member and transmits this dashboard to the node for display on the new member's screen. The dashboard is generated by an html or web template. This template is populated with the logged in member's information, which in turn is received from the data base. Membership information unique to the member is retrieved from the database 18 of host 2 and displayed on the screen of nodes 6a-c.

Registration step 12 as a new member requires the user to enter an e-mail address, which is then confirmed at steps 13 and 15. If confirmed, the new member may be asked to create a user name and password, or alternatively this may be assigned to the member by host 2. The new member is registered as either a private or public user wherein a public user is normally a commercial entity that supplies or designs products or services and normally operates a commercial website. A private user can be an individual or other entity who wishes to participate in the system in a non-commercial fashion. The new user can select to either redirect at step 9 to the home page 7 or proceed to an appropriate private dashboard 16.

Once the initial log-in steps or registration steps are performed and dashboard 16 opens to the member, membership information of the member is retrieved from host database 18 is made available to the member. Following this step, the member, member's node 6 presents the new or existing member with a series of options at step 21:

(1) At step 28, any one of members 6a-6d may create a new tag 24 for an existing sample bag associated with that user or edit an existing tag 24. Tags 24 are displayed on the user's screen and act as an organizing tool to allow members to group their sample bags 110, 112 according to criteria or categories selected by the user. For example a tag might related to a selected the colour; all sample bags containing that colour may then be displayed together on the user's screen when this tag is selected. Alternatively, the tag might relate to a specific article type, such as scarves, lighting fixtures, etc.; selection of one such tag causes the user's sample bags that correspond to this selection to be displayed on the screen. The computer can also search for related terms; for example if the colour “blue” is selected, the search may include “indigo”. The search may also comprise an image-recognition search, such as recognition of the colour blue within images of samples in stored sample bags within the database of host 2.
(2) At step 32, the member at node 6b may generate a list of contacts or download from host 2 and display a stored list of contacts. At step 34, the screen displays a list of other members who have been requested to connect with the logged in member. Once presented with a list, the member is presented with the following options: a) have the system filter or sort the listed contacts at 36: a selection box is displayed on the member's UI wherein when clicked or selected, the listed contacts are automatically sorted alphabetically; b) generate a contact group at 38 and/or assign specific contacts to populate these groups; to create a new contact group, the member clicks on a box on his UI which in turn displays a text field for entering a group name.

When a group name is entered and saved, it is stored in the database after which the member can assign any of these contacts to the group by selecting them, then selecting the group and saving it; and c) sending a new contact request at 42 to current members. To select this option, the user clicks on the “new request” button after which a text field is displayed for entering the email address or user name of the registered member to whom this member like to connect. If the member selects the option of sending a new contact request 42 to another member, host 2 is triggered to send an e-mail to the selected member node 6c at 44, designated as an “invited member”.

Once the prospective member has accepted the request, host 2 adds this person to the list of contacts at 46 associated with the invitor member at 6b. At step 48, node 6b may display new contact requests submitted by one or more other members, designated as invitor member node 6e. Following step 48, node 6b can display the email request from invitor node 6e at step 50, and the user can be presented with the options to either accept at 52 or reject at 54 their request. The member 6b may import contacts at step 58 from other social networks such as Facebook or Twitter and then either accept at 60 or reject at 62 the terms offered by the other social network, which either imports or not imports one or more contacts from such other social networks. At the request of a member at node 6b, host 2 can synchronize public samples within his account with an account at another social network at step 64. In this option, node 6b provides the option of permitting member 6b to synchronize another social network such as Facebook or Twitter or remove such social network from synchronizing with the member's account, at steps 66 and 68 respectively. When a social network is synchronized with the member's account, any publicly shared sample bag associated with member 6b will automatically be shared with that member's contact list within that social network. If a decision is made to remove a selected social network from the member account, the publicly shared samples will no longer be automatically shared in this manner. It will be seen that the above steps can be taken in identical respects between any of members 6a-6d; the selection of members 6b and 6e is purely for convenience of description.

(4) A member can select at step 33 to view samples bags that have been shared with the member by other members. If this option is selected, host 2 generates and transmits to the member at 602 a list of samples and sample bags of other members that have been shared with the first member.

(5) A member can select at step 35 to view samples or sample bags that he has shared with other members. If this option is selected, host 2 generates and transmits to the member a list at 604 of all samples and sample bags that have been shared, as well as the members with whom they have been shared. The member is then presented with the options of removing individual samples from a shared sample bag at step 608; cease sharing a sample bag with the other member at step 610; or allowing/disallowing the other member to add new samples to the shared sample bag at step 612. The member's selected option is transmitted to host 2, which then updates its database to store the selected option.

(6) A member can select at step 37 to add a new sample bag to his collection of sample bags. The member clicks on the “add new sample” button on his screen at step 39, which communicates this option to host 2. Host 2 generates a pop-up window for display on the member's screen at step 41. The member may then enter a title and descriptive information for the new sample bag at step 43, which are transmitted to host 2. Following this step, the member may generate one or more “tags” or select existing previously created tags at step 45 for the new sample bag or alternatively select one or more existing tags. Creation of tags is shown in more detail in Steps 620 and following. At this stage, tags are transmitted from host 2 and two options are displayed in a sidebar of the member's screen. The member has the option to click on a specific tag at 624 to view only existing sample bags containing this tag. Alternatively, the member view all tags at step 622 by clicking on the option “my tags”. This generates a display of all current tags of the member at step 626. The member is also presented with a first option at 628 of editing or deleting an existing tag at 632. For this purpose, the member may select at 634 to change the colour of the tag and/or the text. The tag information is then updated at 636 in the host database. A second option at 630 is for the member to add a new tag. For this option, the member is presented with a pop-up window at 638 with the option to enter a new tag name at 640, which is then saved to the host database at 642.

Returning to step 37, following the creation/selection of one or more tags at step 45, the member may “sample” the new sample bag at step 47. This presents the member with a view of his new sample bag. The member can add virtual products or services into the bag at this stage by “dragging” virtual products or services in the sample bag, such as images, video etc. The completed sample bag is then transmitted to host 2 and stored in the host database at step 49.

(7) At step 70, a member may browse his own existing sample bags 110, 112. For this option, sample bags that have been previously generated by or shared with that member are also displayed The screen may display all of the member's sample bags or any subset thereof according to selection criteria defined by the system. With respect to each sample bag 110 or 112, the member's screen displays the following options available to the user:

(a) The member may delete or edit the information relating to an existing sample bag, including the title, description or tag at step 72.

(b) The member may open an existing sample bag at step 74. At this step, the user's screen depicts the contents of the sample bag at step 76, namely the virtual samples 114 contained in the bag as well as any tags associated with the bag and/or individual samples within the bag. For an opened sample bag, the user's screen displays the following options:
(i) The member may edit samples within the sample bag at step 78, including renaming or deleting individual samples 114. Once this step is concluded, the host database is updated at 80 with the new sample information or to remove any deleted samples within the sample bag.
(ii) The member may add new samples to the sample bag at 82. For this option, a pop-up window is displayed at 84 and the member may either add a single sample at 86, including descriptive characteristics of the sample. This step is performed by uploading any combination of text, images, videos or other data to host 2. The sample and accompanying tags are saved to the database within the host computer 2 at step 88 in association with the member's account. Alternatively, the member may add multiple samples at once at 90, including characteristics such as price, material, colour, etc. which may apply to all of the samples. The information relating to multiple samples is then saved at 92 to the host computer, in the member's account.

(c) The member may click on a picture of the sample at 120. This causes host 2 to load the “sample view” page on the node at 122 for display of detailed information relating to the selected sample 114 on the user's screen. Individual samples 114 within the sample bag 110 or 112 are individually displayed on a larger scale at 124, optionally accompanied by the characteristics previously entered by the member or a previous member. The user's screen displays three options with respect to each sample.
(i) Node 6b can display comments at 126 that have been submitted by other members with respect to the sample. An additional comment 128 can be entered at node 6b by the member with respect to his own sample, which can be added to either the public or private comments section at 130. At this step, when a comment is made, the comment text and current sample identification is added as a new entry in a “comments” table in the host database. As well, a flag indicating whether the comment is public or private is added to the table row. To view the comment, the database is queried by as to whether the comment is public or private and compares this with the permissions of the viewer. The host database accumulates all results corresponding to the public/private parameter of the viewer and displays all related comments and other information to the user according to the user's status.
(ii) The member can edit the sample characteristics or delete the entire sample at 132. If this step is performed by the user, the host database is updated and reconfigured to delete or revise the data selected by the user.
(iii) The member can share the viewed sample 114 with other selected members at 134. For this purpose, node 6b displays a list of members at 136 that have been granted permission to share the sample 114. Optionally, any of these members can be removed at 138 from the list of members entitled to share the specific sample 114, although the comments from deleted members may be retained within the comments section at 140.

(d) At step 200, a public member 6a is provided with the option of selling or purchasing a private or public sample bag 110 or 112, either as the entire bag, or individual samples within the bag. To exercise this option, the member's screen displays a pop-up window or other display form at 202 which presents the member with a first option at step 204 to list a private sample bag no and the samples contained within it in the “marketplace” section of the website operated by the host computer accessible to members. The member is charged a fee at 206 for electing this option, for example by payment via a credit card or PayPal or similar account. Payment is made automatically by updating the host database to communicate payment information to the payment provider to debit the member or alternatively by automatically generating an invoice. Optionally, the member may elect to “feature” the sample bag in the marketplace section at 208, at additional cost. A “feature fee” is added to the total listing fee at 212b which is then charged to the member. The featured sample bag is added to the “public section” portion of the website operated by the host computer. The member selects at 212a which samples within the sample bag will be for sale or “for promotion”, and may identify each sample accordingly, for example by clicking a selected box adjacent to each sample on the user interface or other suitable method. The sample bag with the samples that have been added to it, along with the information as to whether each sample is for sale or for promotion, as well as price and other information, is then added to the marketplace/public section of the primary website operated by the host computer at 214. A second option at 216 is for the public member 6a to directly designate a public sample bag 112 as being a “featured sample bag”. A fee is charged to the public member at 218 and this featured sample bag is then placed at 220 in the “public section” of the website operated by host 2 for sale to the public independently of the present system, for example through an on-line sales arrangement operated by the commercial user.

(e) At step 300, a member 6a-6d is provided with the means to “share” a sample bag no either with other private member nodes 6a-6d at step 302 and/or publicly share the sample bag at 304. If the sample bag no is publicly shared, members at 6a-6d can optionally allow public commenting on the sample bag at 306. The choice between public and/or private sharing of the sample bag is made by clicking on an appropriately identified box on the user interface displayed on the member's screen, located adjacent to the depiction of the sample bag. For private sharing of the sample bag at 302, the member may enter e-mail addresses or other identifiers of co-members at 310 that the member desires to share the sample bag with. This step which allows shared members to add samples 114 to the shared sample bag at step 312. The member may also select which individual samples 114 in the sample bag 110 he wishes to share with other private members at step 314. For this purpose, the entire sample bag need not not shared, but rather designated individual samples in a given sample bag are shared with other members. The member then clicks on the “share samples” box adjacent to the sample bag on the interface at step 316, which triggers e-mails sent to other members at 318 who have been given permission to share the samples. If the recipient of the e-mail is not recognized at 320 by the host computer as being a member, that person is presented with a link in the e-mail at 322, which directs him at 324 to a secure page within the website operated by the host computer which comprises a “template page”. The template page will provide a picture of the shared sample bag, and request the recipient to register with the system. Optionally, a registration form can be displayed on the recipient's screen. Once the recipient registers at 326 with the host computer, he will gain access to the shared samples contained within the sample bag, and will be e-mailed a link to a secure website page that provides the “sharing” options.

(f) If the e-mail at step 318 is sent to a new or existing member node 6c at 330, the selected recipient 6c is allowed to share in the selected sample bag. At step 332, identifying information respecting the sharing member is stored in a database in the host computer as a relation between the first member who is the immediate owner of the samples in the sample bag, and the second member with whom the samples have been shared. At this step, the samples are not duplicated for each member; rather, they are simply available for viewing by the second member. By indicating a relation between the first and second members, the shared sample is only entered in the database associated with the first member. However, there is an option for the second member to download the shared sample to his own sample bag. Once the relation between the first and second members is established, the selected samples will be available for viewing by the second member 6c at step 334 on the second member's website page, indicated as “stuff shared with me”. These samples may be available on a separate website page unique to the second member, accessible by a link on the primary website page of the second member. The second member will be presented with options on the user interface respecting the shared samples at step 336, including “sample it” which results in a downloading of the shared sample to a selected sample bag of the second member's own collection of sample bags.

The public section/marketplace portion 30 of the system is depicted graphically in FIG. 3. This section is available for interaction by the general public, namely node 6e which can connect to host 2 via cloud 4 as well as any private member 6a-6d. For convenience, the present description will refer to use of this section by a public user 6e. Through this site, a user 6e may access data from host 2. Public sample bags 112 and virtual samples 114 within bags 112 can be accessed at node 6e, including those that are “featured” and/or available for sale. Node 6e can access at step 400 a page that has a user interface that lists or otherwise identifies sample bags 112 within the section. Feature items are displayed on the screen of node 6e with enhanced prominence, for example by being presented on top of the user interface page or with a colored background. Sample bags 112 may be displayed at node 6e in random order. This page also comprises a “pre-search” step 402, that invites the visitor to conduct a search for specific categories of sample bags. The user interface includes a “search” function 404. The user may enter one or more search terms, which are then transmitted to the host computer. The host computer employs search and/or filter tools to identify one or more selected sample bags from within the public section that match the criteria selected by the visitor.

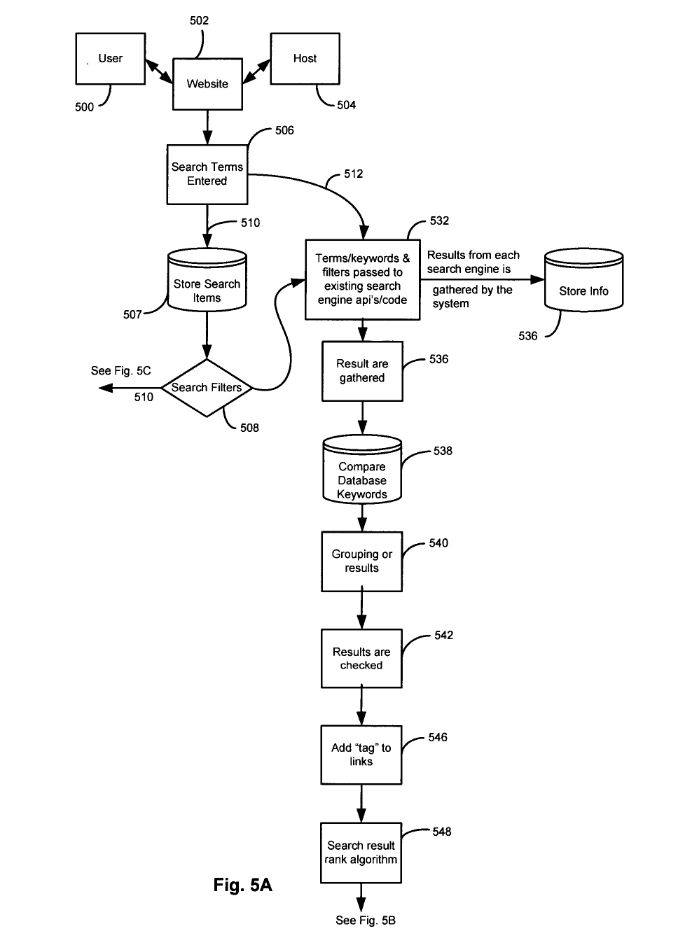

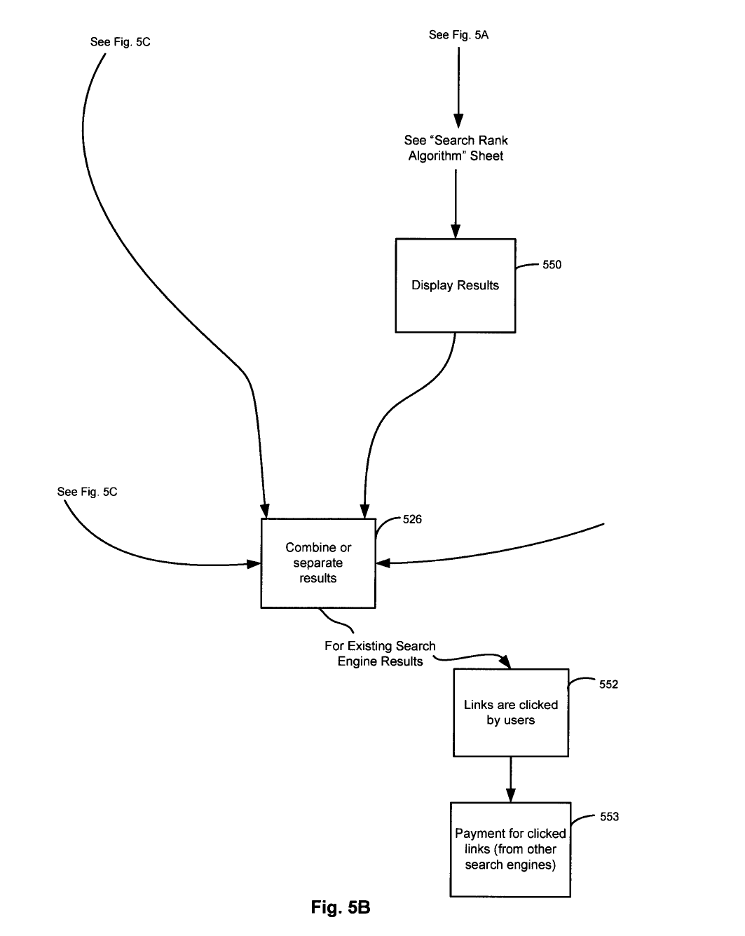

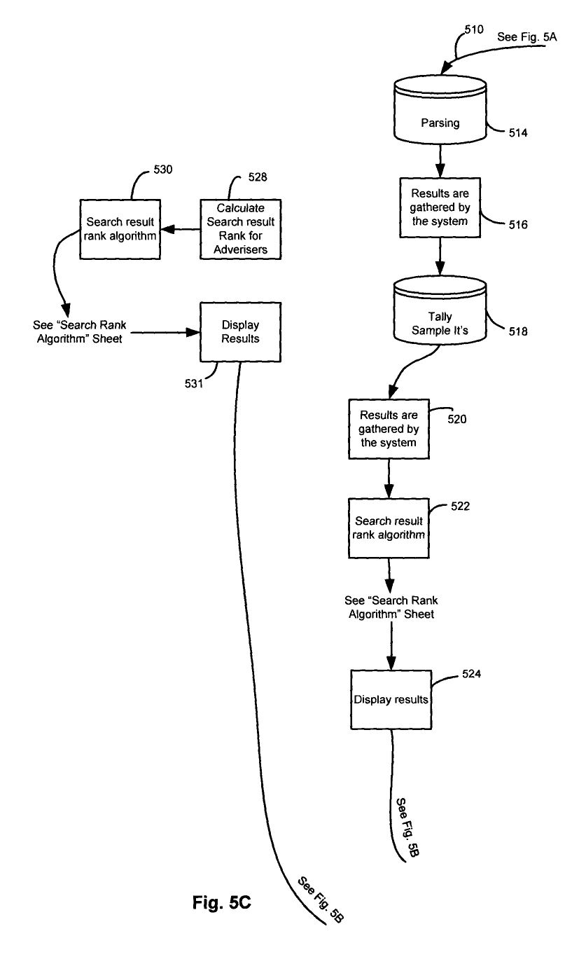

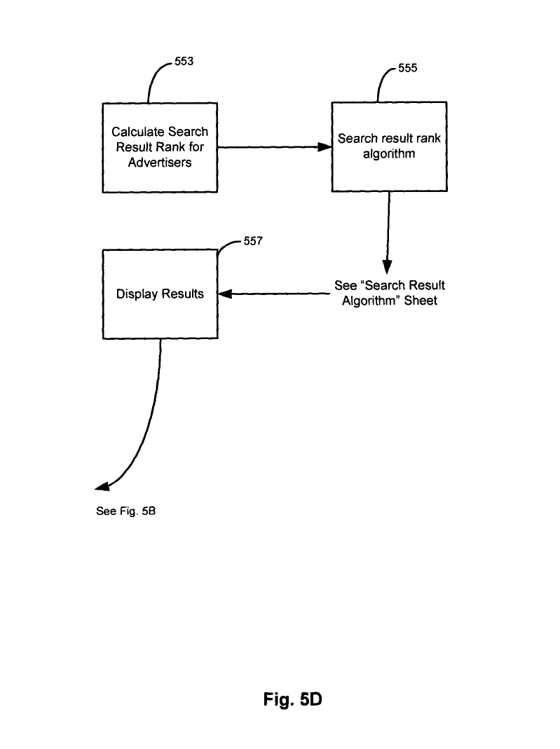

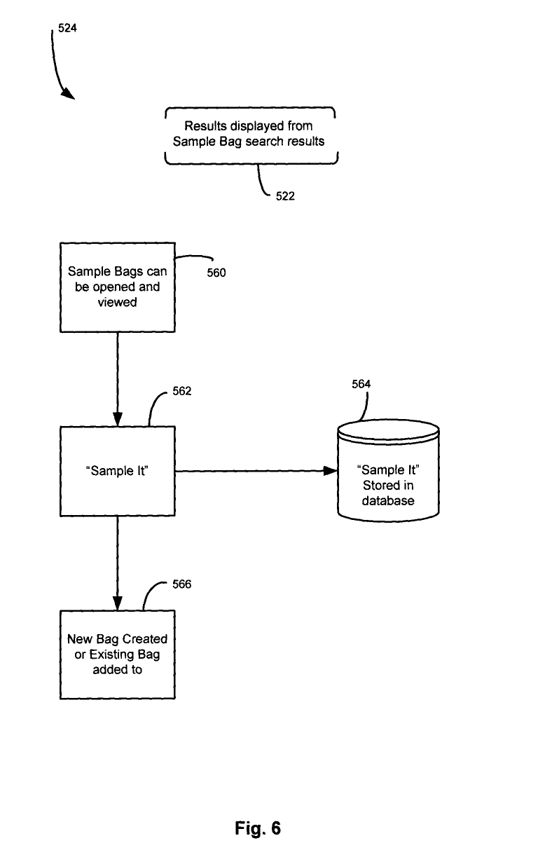

When a user 6e accesses public section 30, a search bar 406 is displayed on the public section website page, which permits entry of search terms for public sample bags. The user enters a search query at 408, which is transmitted to the host computer for database searching. An example of a search sequence is described below by reference to FIGS. 5 and 6.

If the user does not conduct a search, the user may select one of the randomly displayed sample bags 112 displayed in the opening web page. Any of the sample bags can be opened for viewing the samples contained in the bag. Opening of the sample bag at 420 displays individual samples and their characteristics at 422 on the user interface of node 6e. If commenting is allowed on the samples or sample bag, any private member 6a-6d can enter comments at 424

Each public bag 112 has a “sample it” option at step 430 which is viewable by all visitors but is accessible for the “Sample it” function only to private members 6a-6d. This option may be actuated by, for example, a box on the UI of node 6e that may be clicked by the user. The “sample it” button will allow registered members to add public sample bags to their own private collections of sample bags at 432 or their public collections of sample bags at 434. A member may also purchase a sample bag 112 at step 436 if the sample bag is for sale. Sample bags in the user's private collections will not be visible in a member's public collection. If the user adds sample bag 112 to his public collection at 434, the sample bag becomes “re-sampled” and is available for view by any visitor to the site, including the general public, and also for “resampling” by private members. Since a sample bag that is privately shared can also be publicly viewed, the “sample it” function is only accessible to sample bags that are both public and private, but not those that are only privately shared.

If the member 6a-6d opts to purchase the sample bag at 436, the node 6 of the prospective purchase is linked to a website of vendor 6a at step 438. Normally at this point the vendor's payment screen is displayed to the member for direct purchase from the vendor. Once the viewer has been connected to the seller's website, the sale transaction can occur in the manner selected by the seller, independently of the host computer operating the “sample bag” website.

FIGS. 5A-5D show a flowchart that shows an overview of a search system according to the invention. According to this aspect, a user 500 at a local terminal or node 501 which is connected to the Internet accesses a search website 502 generated by host computer 504. Website 502 is linked over the Internet with host computer 504, which has a search engine computer program encoded therein to perform the steps described herein. The user enters one or more search terms and enters these into node 501 at step 506. For example, the user may search for “shirt” or a more specific search such as “men's blue cotton dress shirt”.

Host computer 504 then bifurcates the search query into two discreet searches pathways. A first search. 510 consists of a “sample bag search” that searches exclusively within the sample bag storage/database 18 described above of host 504. This search is conducted within information contained within public and private sample bags stored within database 18 of host 504. The nature of the search conducted will depend on whether the user 500 is a public or a private member. If user 500 is a public member, the search is conducted within public sample bags. If the user is a business member or a private member, the search is conducted within all available sample bags. A second independent search 512 is a public web-based search which is conducted within all publicly available data contained in the worldwide web, as described below.

Sample bag search 510 comprises an initial step 507 wherein the search terms are stored in a database of host 504. Optionally, the user may select one or more filters 508. The search terms are transmitted over the network to host 504. Optionally, host 504 stores the search terms entered by the user in its database for performing future comparisons with search requests.

Examples of filters at this stage include:
buy/sell
industry specific filters, by industry name
geographic location such as a country or region of the seller/provider, determined textually or by a mapping function
Colour, selected from a predetermined list of colours or alternatively by image recognition
popularity

Search 510 then provides a parsing step 514. In this step, existing public samples and sample bags are parsed for selected search terms. These search terms are compared against previously saved data regarding the samples in bags contained in database 18. For example, for a user-generated search query “blue cotton men's dress shirt”, host 504 will search for any combination or isolated ones of the terms “blue/cotton/men's/dress/shirt”. Host 504 includes a thesaurus function whereby terms having a similar meaning may be included in the search such as “indigo” in addition to blue, or “formal” or “business” in addition to “dress”. Parsing step 514 may comprise either key word searching and/or image-based searching within the database of host 504 of existing sample bags. For example, if the colour “blue” is part of the search request, host 504 may search for images of articles that have a blue colour, whether or not the term “blue” appears in the written description of the article. The parsing step can search for data relevant to existing sample bags such as price, geographic location, web url, tiles and other selected aspects and perform a parsing step to select for specified variables therein. At step 516, the results of parsing step 514 are gathered by the system and compiled.

Following compiling step 516, host 504 performs a tallying step 518. In this step, host 504 generates a temporary database of all sample bags and individual samples within the bags that contain the selected search terms. Included in temporary database 518 is the identification of the samples and sample bags, as well as their price, location and other relevant information. At step 518, host 504 identifies the number of “sample it” entries stored within database for each “sample” identified in parsing step 516 based on the stored information generated by previous users of the sample bag network. In order to generate the historical data for use in step 18, database 18 is updated whenever a member creates a sample bag. At this time, characteristics of the sample bag are stored in tables in database 18. Each column in the database can represent, for example, title, description, date/time of creation, and member ID. Similarly, when a sample is created its characteristics are stored in database 18 in a similar fashion with columns representing such variables as price, colour, material, member ID and others.

When a member selects the “sample it” function for a given sample bag or sample, a separate table in database 18 maintains a record of each such request for a given sample bag or sample along with the ID of the member who has selected this function in a separate column. The tallying performed in step 518 is based on the number of times system-wide users have selected the “sample it” option for each sample identified in search 510. This step identifies the number of times that each sample has been placed in the “sample it” database of a member, thereby providing a proxy of the popularity of a given item.

Following tallying step 518, host 504 performs a further results gathering and compiling step 520 wherein the data concerning the number of times each item has been flagged with a “sample it” request prior to the present search is entered into a temporary database in host 504. In this step, the parsed search results from step 516 and the tally of previous “sample it” requests obtained in step 518 are compiled.

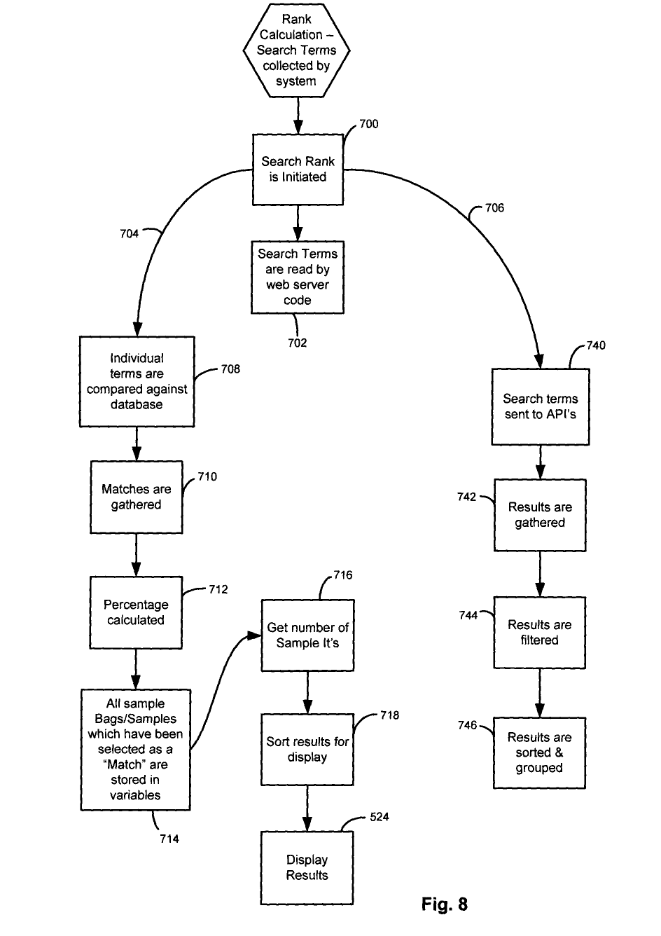

The results from compiling step 520 are then subjected to a ranking step 522 wherein the search results from step 520 are ranked according to predetermined criteria. Particulars of the ranking steps employed by the present system are described below with reference to FIG. 8.

The ranked results are then displayed to the user at step 524. The displayed results can take the form of sample bags transmitted to and displayed on the user's computer node. The relevancy and display order is based on a percentage match with the search terms input by the user, integrated with the number of “sample it” requests for the located samples/sample bags. For this purpose, the two aspects are combined to generate a single display order/ranking.

Following display step 524, host computer 504 combines the results of search 510 with the results of search 512, described below, in a results combining step 526.

In an optional series of steps, advertising revenue may be generated for the operator of host 504 based on the search conducted by the user. According to this option, the results compiled at step 520 are transmitted at step 528 to an advertiser database which performs an independent ranking of results at step 530 from within the ranked results generated at step 520, limited to samples or sample bags located in the search that have been supplied by paying advertisers. Such advertisers may be under contract to provide payment based on a “pay per click” or key word payment for featured bags. The results of this ranking step can be displayed to the user at step 531. Payment information generated as a result of this search is tabulated and stored in the database of host 504. The results from the algorithm performed at step 530 are combined at step 526 with the search results generated by sample bag search 510 and global search 512.

Search 512 is performed independently of search 510 and normally concurrently therewith. Search 512 is performed based on publicly available websites and other databases within the entire world wide web network. Search 512 can comprise a “meta search” in which multiple searches are conducted using existing search engines such as Google, Yahoo, etc. In order to perform this search, search terms entered at 506 and optional filters entered at 508 are input to selected search engines in the form of a search API code in order to produce multiple search results, at step 532. The results are gathered at 534 from the search engines. At step 536, the multiple search results are stored as a temporary file within host 504, which may be used for caching, indexing and other steps to perform future searches faster and more accurately.

At step 538, the results initially gathered at step 534 are compared against a database of previously indexed key words that are stored in host 504 for parsing and auto-grouping of results. At this step, the results of step 534 are parsed to identify selected key words stored in host 504. These previously indexed key words may contain selected website URL's or parts thereof that may be relevant to the search. For example, relevant key words can include websites such as Amazon.com or E-Bay.com to search for items listed for sale.

At step 540, the search results are grouped based on predetermined parameters and/or key words or variations of such key words which may be either predefined or generated automatically by the system. Groupings may include items that are for sale/rent, general links, geographically organized, organized by industry and other groupings. At step 542 the group results are checked against “sample it” samples and/or sample bags that have been located in search 510. In order to avoid duplication of results between the respective searches, duplicate results are eliminated from search 512.

At step 546, each of the links identified in the search are provided with a tag that identifies the search result. The tag may comprise a website link, text or other information provided from each search provider. This informs the user how the result was generated, for example the specific search engine that provided the result.

At step 548, the results from steps 540 and 542 are ranked and sorted. A ranking can be generated by integrating several factors which can provide primary, secondary and other ranking priorities. For example, the first priority level can relate to the search engine(s) which generated the search results wherein priority is given to search results produced by one or more selected search engines. A secondary priority level can related to the number of times other Sample Bag members have placed specific samples located in search within their own “sample it” sections. The ranking steps are described in more detail by reference to FIG. 8.

The results from public search 512 are then displayed to the user at step 550. Display 550 may take the form of virtual sample bags that are filled with the relevant search results, which may be displayed as images and/or other relevant information in any form. The samples are identified according to relevant titles determined by the host, such as links, buy/sell, rent/lease, physical location/proximity to searcher, etc. The search results may also be ranked at step 550 according to a search rank algorithm.

Following the display step 550, the search results are combined with the search results from search 510 at step 526.

In an optional series of steps show in FIG. 5D, the system can formulate a result rank based on the number of vendors who pay for and/or bid for a ranked position by way of keyword advertising and/or pay per click advertising. For this option, at step 553 a search result rank is calculated by host 504 based on the above ranking information which has been previously stored in the host database. Host 504 then determines the result ranking at step 555 via a known algorithmic method and the resulting ranking information is transmitted to the combining step 552, described below.

At step 526, the results of public search 512 are combined with the results from the Sample Bag search 510. The combined results are displayed together at step 552, which can take a variety of forms, such as a split screen, a chart or graph showing the combined results, as well as text, links, audio, images or other graphical method of displaying search results. Results may be provided audibly and visually, and may also be displayed separately.

In one aspect, the two searches are displayed independently, either on a single display/screen or presented on separate screens and/or sequentially.

Display 550 is interactive and at step 552 permits the viewer to click on the link of a website located as a result of search 512. At step 553, this act generates an automatic transfer of funds from the search engine(s) which located the link to an account linked host 504.

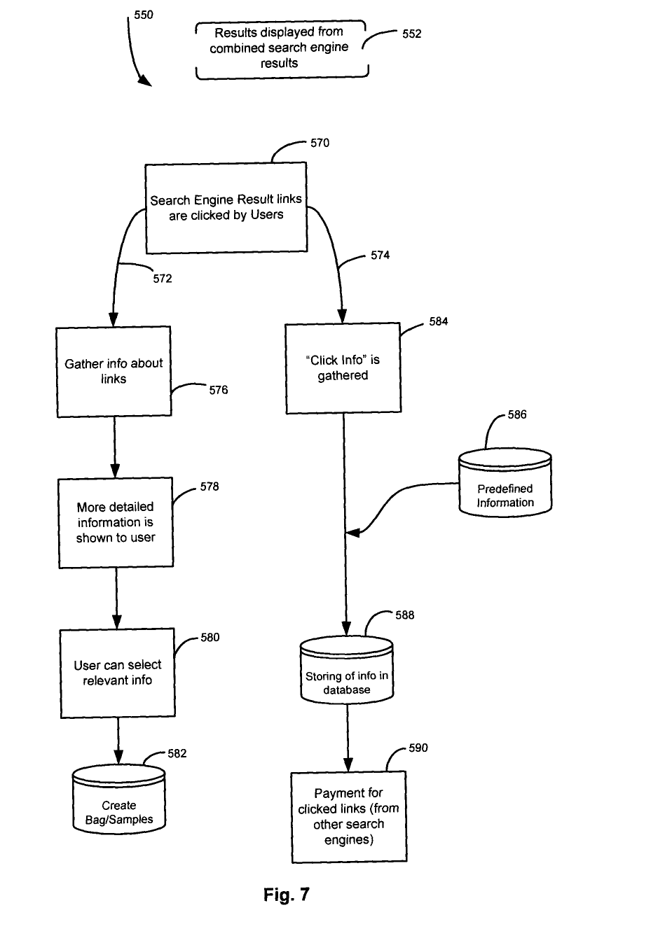

FIGS. 6 and 7 are flowchart that shows steps that a user may initiate with subsequent to the results display at step 552. The user may initiate further steps that differ with respect to the “sample bag” search results from search 510 displayed at 552 and the “web search” results from search 512. FIG. 6 shows the optional further steps that may be performed for the search results generated by search 510. At step 560, the user may select one or more sample bags from the displayed results for viewing their contents. The user selection may take the form of “clicking” on an image of the sample bag or otherwise. The user may then select individual samples from within the sample bag at step 562. These selected samples can be labelled with the “sample it” indicator and stored at step 564 within the “sample it” database for the user. Selection of a “sample it” signifier for an article is tabulated within host 504, which increments by +1 for that sample in a database table within host 504. The database table compiles the accumulated total of “sample it” selections for each individual sample located within the entire database of host 504, namely all undeleted samples that have been entered historically by users of the system. The “sample it” count is continuously counted for each sample within the database. This step permits host 504 to continuously update the sample it count number for samples for use in ranking of future searches of similar articles. As well, selection of a “sample it” signifier by the user may allow the user to connect to a URL specified by a given sample by displaying the appropriate link to the user.

At step 566, when the user selects “sample it” for an article, the user is presented with the option to create a new sample bag for the article or select an existing sample bag belonging to the user, in which to add the selected sample.

FIG. 7 shows steps that the user may initiate for the “public” search results generated with search 512, in which display 552b is generated by this search. At step 570, the user is presented with the option of clicking on a search engine link relating to a given search result. Clicking on the search result at 570 initiates a sample bag creation sequence 572 and a payment sequence 574. Turning to sequence 572, host 504 reviews the information within the selected link and parses the web page or pages which are opened by the link. Selected data is extracted from the pages which may be in the form of images, text, additional URL's/links and other data and information, at step 576. When a user opens a link, the system opens the same link internally to parse the link for relevant information within the web pages that the link leads to. The system may parse these pages for images, video, audio or text files embedded in these pages and information relating to such embedded media such as metadata (title, description etc) relevant to the information displayed for a given sample. Such information can include the colour, price, textures etc of the sample. This information is presented to the end user who then has the option to select the generated search link for the user's search results.

At step 578, selective information gathered in step 576 is displayed to the user. The display may take the form of a pop up window or other display method. The display shows the user additional information about the pages to which the link leads organized in a relatively simple format. For example, all images from the website may displayed in a single grouping, with all text and other information in another grouping. At 580, the user can select relevant information such as images or other media displayed at 578. The user may then create a new sample bag or add to an existing sample bag directly from this area by clicking or otherwise selecting a particular image and/or other information. This step stores the new sample bag or additional sample bag information database relating to the user. At step 582, the new sample bags are created and corresponding information is stored in the database of host 504.

Payment sequence 574 generates revenue for the operator of host 504 in response to the selection of individual samples by a user. At step 584, when a user initiates step 576 to gather information about specific links, the selected link is tracked, the tracking step determines the link that is clicked and which search engine supplied the link to the user. As well, the internet protocol or other location/tracking information of the user who clicked the link is determined, if the user is not a registered member who has logged in prior to conducting the search. If, on the other hand, the use is a registered member who has logged in, the identification of this member is gathered.

At 586, information about multiple search engine providers have been previously stored in host 504 database. This information can include a unique identifier which identifies each search engine provider, including the name, description and other information concerning the search engine provider. At 588, the information gathered at step 584 is stored in a database in host 504. The stored information can include the number of links selected by users with respect to each search engine, the internet protocol of internet searchers/membership ID numbers, search engine provider ID, and other information.

At step 590, after host 504 determines which search engine provided the link clicked by the user, the search engine provider is then charged a fee for this click. Every time a link is selected by a user, a payment is transferred from the search engine provider to the operator of host 504, as a referral fee. Alternatively, payment may be transferred on a periodic basis such as daily, weekly, monthly, etc. for tabulated results.

FIG. 8 shows an embodiment of the ranking method performed at various points of the search sequences described above. According to this method, search terms are compiled in the database of host 504 at various steps including steps 522, 530, 548 and 550. A ranking search is then initiated at step 700 by transmitting a code to host 504 that queries the host database. At step 702, the search terms are read in a web server code which accepts the search terms and temporary caches them for comparison in step 704 against all text in the readable database that describes sample/sample bag characteristics such as title, description, price and other attributes.

The search is then split into a search of host database 704 and a web search at 706. In search 704, individual search terms are compared against the host database. The characters used in the search terms are compared against those of each term in the rows and columns of the database tables in host 504 which describe the characteristics of the samples and sample bags stored therein. The comparison may also include a comparison with search terms or phrases used in previous searches by any users which are stored in the host database, and the results of these previous searches may be regenerated. The search includes various combinations of search terms. For example, a search for “blue dress shirt” will generate queries for the individual words as well as all possible combinations of these words.

At step 710, all matches of the search query consisting of samples/sample bags identified in the search, containing exact matches as well as proximate matches, are gathered and stored in the host database. At 712, a percentage ranking is provided wherein an exact phrase match is given a value of 100% with declining percentages for less exact matches. All samples/sample bags which exceed a selected percentage ranking are then stored in the database at step 714. At step 716, all “sample it” queries that have been previous compiled in the host database for the located samples/sample bags are tallied. The results are then sorted at step 718 based on percentage match and numbers of “sample it” results. The primary sorting is based on percentage and secondary sorting on sample it results. For example, if multiple samples/sample bags have a 100% match, they are ranked according to the number of “sample it” queries for each sample/sample bag. The next layer of results consists of the next-closest percentage match, which in turn are ranked according to “sample it” numbers, and so forth. The results are then displayed at 520.

The web search ranking performed at step 706 comprises an initial step of transmitting the search terms of the search to existing search engine application programming interface (API)'s for generating a search result using their respective search interfaces. For example, the search phrase “blue dress shirt” may be sent to the public interfaces of multiple publicly available search engines such as Google, Yahoo etc. The search results are then returned directly to host 504 for further manipulation. At step 742, the search results are compiled. The search results will have been already ranked by the search engine. At step 744, the compiled search results are filtered by the host 504, to eliminate duplicates generated by multiple search engines. Any such duplicated results will still indicate the multiple source search engines that provided the results, for example both Google and Yahoo may be identified as the originator of the result. At step 746, the results are then sorted and grouped. In this step, the pre-grouped and ranked results from the multiple search engines are then combined into a single ranking. For this purpose, host 504 can base a ranking on the history of clicks on each link to determine the total number of times previous users have clicked on the links located in the search. The results are ranked based on the number of such previous clicks, which is a proxy for the popularity and relevance of such links. The ranked results are then stored in a database of host 504 for use in the search sequence where required.

The scope of the invention should not be limited by the preferred embodiments set forth in the examples but should be given the broadest interpretation consistent with the description as a whole. The claims are not to be limited to the preferred or exemplified embodiments of the invention.

1. A computer-implemented method for sharing virtual samples of products and services over a computer network comprising a host computer and multiple node computers associated with users, the method comprising:
providing at the host computer a template accessible over the network to said users for compiling a virtual sample bag comprising an assemblage of virtual products or services comprising computer-readable data, said template comprising a user interface transmitted over the network to a first of said users;
receiving at said host computer over said computer network a virtual sample bag from the first of said users and a designation of the status said sample bag as being private for viewing and sharing only by designated others of said users or public for sharing by designated others of said users and viewing by any person over said network, and configuring a computer database of the host computer to store said sample bag and designated status in a user-searchable format;
receiving at said host a request to share said sample bag from a second of said users;
responsive to said request, identifying from data stored in said host whether said second user is a designated user and transmitting said sample bag for viewing and sharing by a designated one of the second users to the node of said second user, and then updating the host database to designate said sample bag as being shared between said first and second users;
receiving from a designated one of said second users a request to perform one or more of copying at least one of said virtual products or services into a sample bag of said second user, posting a comment in said shared sample bag or adding a new virtual product or service into the shared sample bag; and
updating the host data base to modify the sample bag as requested by the second user and store said modified sample bag.

2. The method of claim 1 wherein the sample bag further comprises at least one tag comprising text, images or other information that describes the sample bag or samples therein, generated by said first user and searchable over said network.

3. The method of claim 1 comprising the further step of synchronizing a user account associated with a user of another data exchange network with said member account wherein contacts and information is shared between said accounts.

4. The method of claim 1 wherein at least one of said users is a commercial entity defined as a public member having a publicly-available website and wherein others of said users can link to said website through a sample bag compiled by said public member.

5. The method of claim 4 wherein a payment is automatically transferred from the pubic member to an account associated with the host when said user links to the public member website from the sample bag of the public member.

6. The method of claim 1 wherein the host further comprises a database associated with the first user of contacts of the first user wherein said host generates private sharing of said sample bags between the first user and at least selected ones of said contacts.

7. The method of claim 1 wherein the step of establishing a shared sample bag comprises the step of establishing a database corresponding to said shared sample bag for storing data corresponding to said shared samples wherein each of said shared samples is identified with the donor source of the sample and the recipient member with whom the sample has been shared.

8. The method of claim 1 comprising the further step of modifying at said host database an existing sample bag generated by the first user by adding one or more virtual samples uploaded by the first user from the web or from another sample bag and/or removing a sample from said sample bag.

9. A computer-implemented method for performing a search over a computer network comprising a host computer and user nodes, said host comprising a database of virtual sample bags comprising an assemblage of virtual products or services wherein said sample bags are compiled and transmitted over the network by users, said search comprising the steps of receiving at said host computer a search inquiry from a first user, performing a first search within the sample bag database of said host, performing a second search within the web and transmitting the results of said first and second searches to said first user.

10. The method of claim 9 wherein said second search comprises the step of grouping the search results according to predetermined categories.

11. The method of claim 10 wherein said categories comprise one or more of a selected price of said samples, geographic location and industry sector.

12. The method of claim 9 wherein said second search comprises a meta search conducted within databases of selected publicly accessible search engines.

13. The method of claim 9 wherein said first search comprises an initial computer-implemented parsing step wherein search terms entered by the first user are compared with data associated with said stored sample bags to generate a parsed search output.

14. The method of claim 9 wherein the first search comprises the further step of ranking the search results according to a combination of relevance to sample bags within said sample bag database and number times said sample bags have been previously selected by others of said users for sampling.

15. The method of claim 9 wherein said first search comprises the further step of compiling a database in said host of commercial users wherein a payment is transferred by said host when a sample bag of one of said commercial users is identified in said search.

16. The method of claim 9 wherein sample bags and/or samples within sample bags identified in said first search can be resampled by said first user over the network to the account of the first user and wherein the host updates its database to tabulate said resampling of the selected sample bag and/or sample.

17. The method of claim 9 wherein the host adds an additional sample or generate a new sample bag of the first user to insert a sample located in said second search, in response to a request by the first user and uploading of computer data by the first user transmitted over the network.

18. The method of claim 1 comprising the further step of providing from said host computer a search function as described in claim 9.

19. A system for exchanging and sharing virtual samples of products or services between members over a computer network comprising a host computer and multiple node computers associated with users, the system comprising:
a computer-generated template accessible over the network to said users for compiling in a database of said host a virtual sample bag or updating existing previously compiled virtual sample bag comprising an assemblage of virtual products or services comprising computer-readable data, said template comprising a user interface transmitted over the network to a first of said users;
a database and computer program on computer-readable media to process and store data at said host transmitted to the host from the first of said users to the host over the network relating to a virtual sample bag and a designation of the status said sample bag as being private for viewing and sharing only by designated others of said users or public for sharing by designated others of said users and viewing by any person over said network;
a computer program on computer-readable media for receiving a request at said host to share said sample bag from a second of said users and responsive to said request, causing said host computer to identify from data stored in said host whether said second user is a designated user and transmitting said sample bag for viewing and sharing by a designated one of the second users to the node of said second user, and then updating the host database to designate said sample bag as being shared between said first and second users;
a computer program on computer-readable media for receiving at said host from a designated one of said second users a request to perform one or more of copying at least one of said virtual products or services into a sample bag of said second user, posting a comment in said shared sample bag or adding a new virtual product or service into the shared sample bag; and for updating the host computer database to modify the sample bag as requested by the second user and store said modified sample bag.

20. The system of claim 19 wherein the sample bag further comprises at least one tag comprising text, images or other information that describes the sample bag or samples therein, generated by said first user and searchable over said network.

21. The system of claim 19 wherein said host synchronizes a user account associated with a user of another data exchange network with said member account wherein contacts and information is shared between said accounts.

22. The system of claim 19 wherein at least one of said users is a commercial entity defined as a public member having a publicly-available website and wherein others of said users can link to said website through a sample bag compiled by said public member.

23. The system of claim 19 wherein a payment is automatically transferred from the pubic member to an account associated with the host when said user links to the public member website from the sample bag of the public member.

24. The system of claim 19 wherein the host further comprises a database associated with the first user of contacts of the first user wherein said host generates private sharing of said sample bags between the first user and at least selected ones of said contacts.

25. The system of claim 19 wherein establishing a shared sample bag comprises establishing a database corresponding to said shared sample bag for storing data corresponding to said shared samples wherein each of said shared samples is identified with the donor source of the sample and the recipient member with whom the sample has been shared.

26. The system of claim 19 wherein the computer program of said host modifies an existing sample bag generated by the first user by adding one or more virtual samples uploaded by the first user from the web or from another sample bag and/or removing a sample from said sample bag.

27. A system for performing a computer-implemented search over a computer network comprising a host computer and user nodes, said system a computer program stored on a computer program medium, a host computer and a database of virtual sample bags comprising an assemblage of virtual products or services wherein said sample bags are compiled and transmitted over the network by users, said computer program being programmed to perform a search comprising the steps of receiving at said host computer a search inquiry from a first user, performing a first search within the sample bag database of said host, performing a second search within the web and transmitting the results of said first and second searches to said first user.

28. The system of claim 27 wherein said second search comprises the step of grouping the search results according to predetermined categories.

29. The system of claim 28 wherein said categories comprise one or more of a selected price of said samples, geographic location and industry sector.

30. The system of claim 27 wherein said second search comprises a meta search conducted within databases of selected publicly accessible search engines.

31. The system of claim 27 wherein said first search comprises an initial computer-implemented parsing step wherein search terms entered by the first user are compared with data associated with said stored sample bags to generate a parsed search output.

32. The system of claim 27 wherein the first search comprises the further step of ranking the search results according to a combination of relevance to sample bags within said sample bag database and number times said sample bags have been previously selected by others of said users for sampling.

33. The system of claim 27 wherein said first search comprises the further step of compiling a database in said host of commercial users wherein a payment is transferred by said host when a sample bag of one of said commercial users is identified in said search.

34. The system of claim 27 wherein sample bags and/or samples within sample bags identified in said first search can be re-sampled by said first user over the network to the account of the first user and wherein the host updates its database to tabulate said re-sampling of the selected sample bag and/or sample.

35. The system of claim 27 wherein the host can add an additional sample or generate a new sample bag of the first user to insert a sample located in said second search, in response to a request by the first user and uploading of computer data by the first user transmitted over the network.

36. The system of claim 19 wherein said host further comprises the database and computer program for performing a computer-implemented search as described in claim 9.
